(19) United States
(12) Patent Application Publication
(10) Pub. No.: US 2025/0287475 A1
(43) Pub. Date: Sep. 11, 2025

(54) FURNACE HEAD FOR USE WITH AN INDUCTION FURNACE AND METHOD OF USE THEROF

(71) Applicant: Mark Kohler, Hartville, OH (US)

(72) Inventor: Mark Kohler, Hartville, OH (US)

(21) Appl. No.: 18/597,042

(22) Filed: Mar. 6, 2024

(51) Int. Cl. H05B 6/22; H05B 6/36

(52) U.S. Cl. CPC H05B 6/22; H05B 6/367

(57) ABSTRACT

An adjustable head system of an induction furnace and method of use thereof. The adjustable head system includes a head, an apron that operably engages with an outer shell of the induction furnace, and at least one head drive assembly that operably engages with the apron. The at least one head drive assembly is configured to automatically adjust the head along an axis angled relative to the apron upon assembly of the induction furnace, upon disassembly of the induction furnace, or during a melting operation of the induction furnace.

### TECHNICAL FIELD

This disclosure is generally directed to induction furnaces, specifically coreless induction furnaces that are automatically adjustable.

### BACKGROUND ART

Induction furnaces, either coreless or channel, operate by transferring high and/or extreme amounts heat energy via a high-voltage primary coil that induces a high current with a low voltage. Generally, these types of furnaces are efficient at melting a wide array of metals while maintaining a low level of melt loss during melting operations. In regards to coreless induction furnaces, coreless induction furnaces include at least one power coil that is the primary heating component of coreless induction furnaces. Generally, the power oils provided in these coreless induction furnaces are highly conductive copper tubing and are wound into helical coils before being placed inside of steel casings or outer shells of coreless induction furnaces. As stated earlier, these coreless induction furnaces generate high and/or extreme amounts of heat energy through these power coils at high current values where frequencies may vary between about 50 cycles per second up to about 10,000 cycles per second, which may generate extreme amounts of power that can be applied to these furnaces.

With such extreme power and heat, metal materials may be provided in a molten state based on the interaction between the magnetic fields and electrical currents generated by the power coils of these coreless induction furnaces. With these magnetic fields and electrical currents, a stirring reaction is produced inside of the coreless induction furnaces to mix alloys inside of these coreless induction furnaces or to distribute temperature evenly throughout these coreless induction furnaces. However, such extreme power and heat generated and applied inside these furnaces during melting processes via these power coils leads to deformation and destruction to components inside of these furnaces, specifically shunts and heads of these furnaces.

To combat these issues, conventional coreless induction furnaces may include coils that are fluid-cooled (e.g., water-cooled or other fluids of the like) via a recirculating tower or machine. Conventional induction furnaces may also include cooling coils located above or below the power coils for further cooling to reduce heat. However, such cooling of these power coils may fail to alleviate unwanted pressure and stress placed on the shunts and heads of coreless induction furnaces during melting processes. Moreover, such shunts and heads are constantly maintained at a sustained pressure with the power coils of coreless induction furnaces which ultimately leads to warpage and deformation of these shunts and heads.

Furthermore, when warpage and deformation of these shunts and heads occur due to numerous melting processes occurring inside of coreless induction furnaces, dissembling and reassembling of these coreless induction furnaces is time consuming, labor intensive, and dangerous to operators. Currently, groups of operators must continuously work for long periods of time in order to dissemble and reassemble these coreless induction furnaces without causing further damage to the coreless induction furnaces and injuries to operators due to extreme pressure applied between the power coils and the shunts and heads. Such disassembly and reassembly of these coreless induction furnaces are vastly time consuming, which leads loss in profits from using these coreless induction furnaces due to lack of melting metals and/or mixing of metal alloys.

### SUMMARY OF THE INVENTION

In one aspect, an exemplary embodiment of the present disclosure may provide an adjustable shunt system of an induction furnace. The adjustable shunt system includes a shunt that operably engages with at least one cooling coil of the induction furnace and a power coil of the induction furnace. The adjustable shunt system also includes a support column that operably engages with an outer shell of the induction furnace. The adjustable shunt system also includes at least one shunt drive assembly that operably engages with the support column and the shunt. The at least one shunt drive assembly is configured to automatically adjust the shunt along an axis angled relative to the support column.

This exemplary embodiment or another exemplary embodiment may further include that when the shunt is adjusted by the at least one shunt drive assembly, the at least one cooling coil and the power coil are adjusted with the shunt. This exemplary embodiment or another exemplary embodiment may further include that the at least one shunt drive assembly comprises: a first jack having a first end that operably engages with the shunt and a second end opposite to the first end; and a first motor operably engaged with jack; wherein the first motor is configured to linearly move the first jack and the shunt along the axis angled relative to the support column. This exemplary embodiment or another exemplary embodiment may further include at least another shunt drive assembly operably engaged with the support column and the shunt; wherein the at least another shunt drive assembly is configured to automatically adjust the shunt along a second axis angled relative to the support column and parallel with the axis of the at least one shunt drive assembly. This exemplary embodiment or another exemplary embodiment may further include that each of the at least one shunt drive assembly and the at least another shunt drive assembly adjusts the shunt independently and separately from one another. This exemplary embodiment or another exemplary embodiment may further include that the at least another shunt drive assembly comprises: a second jack having a first end that operably engages with the shunt and a second end opposite to the first end; and a second motor operably engaged with jack; wherein the second motor is configured to linearly move the jack and the shunt along the second axis angled relative to the support column. This exemplary embodiment or another exemplary embodiment may further include that the support column comprises: a top end; a bottom end opposite to the top end; and a passageway defined therebetween; wherein the first motor and the second motor operably engage with the support column inside of the passageway. This exemplary embodiment or another exemplary embodiment may further include a transition plate operably engaged with the shunt, the at least one cooling coil, and the power coil; wherein the transition plate is positioned between the shunt and the at least one cooling coil and the power coil such that the shunt is spaced apart from the at least one cooling coil and the power coil; and wherein the transition plate and shunt are separate and independent of one another. This exemplary embodiment or another exemplary embodiment may further include that the shunt comprises: a first end; a second end opposite to the first end; a first outer surface extending between the first end and the second end; and a first inner surface extending between the first end of the shunt and the second end of the shunt and opposite to the first outer surface; wherein the first outer surface and the first inner surface are substantially planar surfaces. This exemplary embodiment or another exemplary embodiment may further include that the transition plate comprises: a first end; a second end opposite to the first end; a second outer surface extending between the first end of the transition plate and the second end of the transition plate; and a second inner surface extending between the first end of the transition plate and the second end of the transition plate and opposite to the first outer surface; wherein the second outer surface is a substantially planar surface; and wherein the second inner surface is a curvilinear planar surface. This exemplary embodiment or another exemplary embodiment may further include a track operably engaged with the support column; and a sled assembly operably engaged with the track and operably engaged with the shunt at one of a first end of the shunt and a second end of the shunt opposite to the first end; wherein the sled assembly is configured to guide the shunt along the track. This exemplary embodiment or another exemplary embodiment may further include at least one load cell operably engaged with the shunt and the at least one shunt drive assembly; and a controller electrically connected with the at least one load cell and the at least one shunt drive assembly; wherein the controller is configured to automatically adjust the shunt, via the at least one shunt drive assembly, when the at least one load cell measures a pressure that is outside a range of predetermined pressures. This exemplary embodiment or another exemplary embodiment may further include that at least one load cell operably engaged with the shunt and the at least one shunt drive assembly; at least another load cell operably engaged with the shunt and the at least another shunt drive assembly; and a controller electrically connected with the at least one load cell, the at least another load cell, the at least one shunt drive assembly, and the at least another shunt drive assembly; wherein the controller is configured to automatically adjust the shunt, via one or both of the at least one shunt drive assembly and the at least another shunt drive assembly, when at least one of the at least one load cell and the at least another load cell measure a pressure that is outside a range of predetermined pressures.

In another aspect, an exemplary embodiment of the present disclosure may provide a method of automatically adjusting a shunt of a shunt system of an induction furnace. The method includes steps of engaging at least one shunt drive assembly of the shunt system with a support column of the shunt system; engaging the at least one shunt drive assembly with the shunt of the shunt system; engaging at least one cooling coil of the induction furnace and a power coil of the induction furnace with the shunt; and automatically adjusting the shunt of the shunt system of the coreless induction furnace, via the at least one shunt drive assembly, relative to the at least one cooling coil and the power coil.

This exemplary embodiment or another exemplary embodiment may further include a step of advancing the shunt away from the support column and towards the at least one cooling coil and the power coil, via the at least one shunt drive assembly, until a desired pressure is maintained between the shunt, the at least one cooling coil, and the power coil. This exemplary embodiment or another exemplary embodiment may further include a step of withdrawing the shunt away from the at least one cooling coil and the power coil and towards the support column, via the at least one shunt drive assembly, until a desired pressure is maintained between the shunt, the at least one cooling coil, and the power coil. This exemplary embodiment or another exemplary embodiment may further include steps of engaging at least one load cell with the at least one shunt drive assembly and the shunt; and measuring pressure at at least one position on the shunt by the at least one load cell. This exemplary embodiment or another exemplary embodiment may further include steps of sending at least one signal to a controller, via the at least one load cell, when the at least one load cell measures a pressure that is outside a predetermined pressure applied against the shunt; and advancing the shunt away from the support column and towards the at least one cooling coil and the power coil, via the at least one shunt drive assembly, until a desired pressure is maintained between the shunt, the at least one cooling coil, and the power coil. This exemplary embodiment or another exemplary embodiment may further include steps of sending at least one signal to a controller, via the at least one load cell, when the at least one load cell measures a pressure that is outside a predetermined pressure applied against the shunt; and withdrawing the shunt away from the at least one cooling coil and the power coil and towards the support column, via the at least one shunt drive assembly, until a desired pressure is maintained between the shunt, the at least one cooling coil, and the power coil. This exemplary embodiment or another exemplary embodiment may further include steps of engaging at least another drive assembly with the shunt of the shunt system; and automatically adjusting the shunt of the shunt system of the coreless induction furnace, via the at least another drive assembly, relative to the at least one cooling coil and the power coil; wherein the at least one shunt drive assembly and the at least another drive assembly separately and independently adjust the shunt.

In yet another aspect, an exemplary embodiment of the present disclosure may provide an adjustable head system of an induction furnace. The adjustable head system includes a head. The adjustable head system also includes an apron that operably engages with an outer shell of the induction furnace. The adjustable head system also includes at least one head drive assembly that operably engages with the apron. The at least one head drive assembly is configured to automatically adjust the head along an axis angled relative to the apron.

This exemplary embodiment or another exemplary embodiment may further include that when the head is adjusted by the at least one head drive assembly, at least one cooling coil of the induction furnace and a power coil of the induction furnace are adjusted with the head. This exemplary embodiment or another exemplary embodiment may further include that the at least one head drive assembly comprises: a first jack having a first end that operably engages with the head and a second end opposite to the first end; and a first motor operably engaged with jack; wherein the first motor is configured to linearly move the first jack and the head along the axis angled relative to the apron. This exemplary embodiment or another exemplary embodiment may further include at least another head drive assembly operably engaged with the apron and the head; wherein the at least another head drive assembly is configured to automatically adjust the head along a second axis angled relative to the apron and parallel with the axis of the at least one head drive assembly. This exemplary embodiment or another exemplary embodiment may further include that each of the at least one head drive assembly and the at least another head drive assembly adjusts the head independently and separately from one another. This exemplary embodiment or another exemplary embodiment may further include that the at least another head drive assembly comprises: a second jack having a first end that operably engages with the head and a second end opposite to the first end; and a second motor operably engaged with jack; wherein the second motor is configured to linearly move the jack and the head along the second axis angled relative to the apron. This exemplary embodiment or another exemplary embodiment may further include that the apron comprises: a top end; a bottom end opposite to the first end; and a passageway defined between the top end and the bottom end; wherein the first motor and the second motor operably engage with the apron inside of the passageway. This exemplary embodiment or another exemplary embodiment may further include that the first motor and the second motor operably engage with top end of the apron inside of the passageway. This exemplary embodiment or another exemplary embodiment may further include that the head comprises: a top plate operably engaged with the at least one head drive assembly; wherein the top plate is adjustable relative to the apron and at least one cooling coil of the induction furnace. This exemplary embodiment or another exemplary embodiment may further include that the head further comprises: a refractory member operably engaged with the top plate; wherein the refractory member is configured to engage with at least one cooling coil of the induction furnace to maintain a desired pressure on the at least one cooling coil and a power coil of the induction furnace. This exemplary embodiment or another exemplary embodiment may further include that the top plate comprises: a top end; a bottom end operably engaged with the at least one head drive assembly and opposite to the top end; and a retaining arm extending from the bottom end of the top plate; wherein the bottom end and the retaining arm are configured to retain the refractory member with the top plate. This exemplary embodiment or another exemplary embodiment may further include at least one load cell operably engaged with the head and the at least one head drive assembly; and a controller electrically connected with the at least one load cell and the at least one head drive assembly; wherein the controller is configured to automatically adjust the head, via the at least one head drive assembly, when the at least one load cell measures a pressure that is outside a range of predetermined pressures. This exemplary embodiment or another exemplary embodiment may further include at least one load cell operably engaged with the head and the at least one head drive assembly; at least another load cell operably engaged with the head and the at least another head drive assembly; and a controller electrically connected with the at least one load cell, the at least another load cell, the at least one head drive assembly, and the at least another head drive assembly; wherein the controller is configured to automatically adjust the head, via at least one of the at least one head drive assembly and the at least head another drive assembly, when at least one of the at least one load cell and the at least another load cell measures pressure that is outside a range of predetermined pressures.

In yet another aspect, an exemplary embodiment of the present disclosure may provide a method of automatically adjusting a head of a head system of an induction furnace. The method includes steps of engaging at least one head drive assembly of the head system with an apron of the head system; engaging the at least one head drive assembly with the head of the head system; engaging at least one cooling coil of the induction furnace with the head; and automatically adjusting the head of the head system of the induction furnace, via the at least one head drive assembly, relative to the at least one cooling coil.

This exemplary embodiment or another exemplary embodiment may further include a step of retracting the head towards the apron and towards the at least one cooling coil and a power coil of the induction furnace, via the at least one head drive assembly, until a desired pressure is maintained between the head, the at least one cooling coil, and the power coil. This exemplary embodiment or another exemplary embodiment may further include a step of withdrawing the head away from the at least one cooling coil and a power coil of the induction furnace and towards the apron, via the at least one head drive assembly, until a desired pressure is maintained between the head, the at least one cooling coil, and the power coil. This exemplary embodiment or another exemplary embodiment may further include steps of engaging at least one load cell with the at least one head drive assembly and the head; and measuring pressure at at least one position on the head by the at least one load cell. This exemplary embodiment or another exemplary embodiment may further include steps of sending at least one signal to a controller, via the at least one load cell, when the at least one load cell measures a pressure that is outside a range of predetermined pressures applied against the head; and retracting the head towards the apron and towards the at least one cooling coil and a power coil of the induction furnace, via the at least one head drive assembly, until a desired pressure is maintained between the head, the at least one cooling coil, and the power coil. This exemplary embodiment or another exemplary embodiment may further include steps of sending at least one signal to the controller, via the at least one load cell, when the at least one load cell measures a pressure that is outside a range of predetermined pressures applied against the head; and withdrawing the head away from the at least one cooling coil and a power coil of the induction furnace and towards the apron, via the at least one head drive assembly, until a desired pressure is maintained between the head, the at least one cooling coil, and the power coil. This exemplary embodiment or another exemplary embodiment may further include steps of engaging at least another head drive assembly with the head of the head system; and automatically adjusting the head of the head system of the induction furnace, via the at least another head drive assembly, relative to the at least one cooling coil and a power coil of the induction furnace; wherein the at least one head drive assembly and the at least another head drive assembly separately and independently adjust the head.

In yet another aspect, an exemplary embodiment of the present disclosure may provide a method of monitoring pressure applied to a shunt of an induction furnace during a melting process. The method comprises steps of engaging at least one shunt drive assembly of a shunt system with a support column of the shunt system and the shunt of the shunt system; providing at least one load cell with the shunt at a first position and with the at least one shunt drive assembly of the shunt system; connecting a controller of the induction furnace with the at least one load cell; connecting the controller with the at least one shunt drive assembly; and monitoring pressure applied to the shunt of the induction furnace during the melting process by the at least one load cell.

This exemplary embodiment or another exemplary embodiment may further include a step of automatically adjusting the shunt of the shunt system, via the at least one shunt drive assembly of the shunt system, relative to at least one cooling coil of the induction furnace and a power coil of the induction furnace during the melting process. This exemplary embodiment or another exemplary embodiment may further include steps of sending at least one signal to the controller, via the at least one load cell, when the at least one load cell measures a pressure that is outside a range of predetermined pressures applied against the shunt; and advancing the shunt away from the support column and towards at least one cooling coil of the induction furnace and the power coil of the induction furnace, via the at least one shunt drive assembly, until a desired pressure is maintained between the shunt, the at least one cooling coil, and the power coil. This exemplary embodiment or another exemplary embodiment may further include steps of sending at least one signal to the controller, via the at least one load cell, when the at least one load cell measures a pressure that is outside a range of predetermined pressures applied against the shunt; and withdrawing the shunt away from the at least one cooling coil of the induction furnace and the power coil of the induction furnace and towards the support column, via the at least one shunt drive assembly, until a desired pressure is maintained between the shunt, the at least one cooling coil, and the power coil. This exemplary embodiment or another exemplary embodiment may further include steps of engaging at least another shunt drive assembly of the shunt system with the shunt of the shunt system; providing at least another load cell with the shunt at a second position and with the at least another shunt drive assembly; and monitoring pressure applied to the shunt by the at least another load cell; wherein the second position is different than the first position. This exemplary embodiment or another exemplary embodiment may further include that the at least one shunt drive assembly and the at least another shunt drive assembly separately and independently automatically adjust the shunt; and wherein the at least one load cell and the at least another load cell of the shunt system separately and independently monitor the shunt. This exemplary embodiment or another exemplary embodiment may further include steps of sending at least one signal to the controller, via the at least one load cell or the at least another load cell, when the at least one load cell or the least another cell measures a first pressure that is outside a range of predetermined pressures applied against the shunt; and advancing the shunt away from the support column and towards at least one cooling coil and a power coil, via at least one of the at least one shunt drive assembly and the at least another shunt drive assembly, until a desired pressure is maintained between the shunt, the at least one cooling coil, and the power coil. This exemplary embodiment or another exemplary embodiment may further include steps of sending at least one signal to the controller, via the at least one load cell or the at least another load cell, when the at least one load cell or the at least another load cell measures a first pressure that is outside a range of predetermined pressures applied against the shunt; and withdrawing the shunt away from the at least one cooling coil and the power coil and towards the support column, via one of the at least one shunt drive assembly and the at least another shunt drive assembly, until a desired pressure is maintained between the shunt, the at least one cooling coil, and the power coil. This exemplary embodiment or another exemplary embodiment may further include steps of sending at least one signal to the controller, via the at least one load cell, when the at least one load cell measures a first pressure that is outside a range of predetermined pressures applied against the shunt; sending at least another signal to the controller, via the at least another load cell, when the at least another load cell measures a second pressure that is outside the range of predetermined pressures applied against the shunt; and advancing the shunt away from the support column and towards the at least one cooling coil and the power coil, via the at least one shunt drive assembly and the at least another shunt drive assembly of the shunt system, until a desired pressure is maintained between the shunt, the at least one cooling coil, and the power coil. This exemplary embodiment or another exemplary embodiment may further include steps of sending at least one signal to the controller, via the at least one load cell, when the at least one load cell measures a first pressure that is outside a range of predetermined pressures applied against the shunt; sending at least another signal to the controller, via the at least another load cell, when the at least another load cell measures a second pressure that is outside the range of predetermined pressures applied against the shunt; and withdrawing the shunt away from the at least one cooling coil and the power coil and towards the support column, via the at least one shunt drive assembly and the at least another shunt drive assembly, until a desired pressure is maintained between the shunt, the at least one cooling coil, and the power coil.

In yet another aspect, an exemplary embodiment of the present disclosure may provide a method of monitoring pressure applied to a head of an induction furnace during a melting process. The method includes steps of engaging at least one head drive assembly of a head system with an apron of the head system and the head of the head system; providing at least one load cell with the head at a first position and with the at least one head drive assembly of the head system; connecting a controller of the induction furnace with the at least one load cell; connecting the controller with the at least one head drive assembly; and monitoring pressure applied to the head during the melting process by the at least one load cell.

This exemplary embodiment or another exemplary embodiment may further include a step of automatically adjusting the head of the head system, via the at least one head drive assembly, relative to at least one cooling coil of the induction furnace or a power coil of the induction furnace during the melting process. This exemplary embodiment or another exemplary embodiment may further include steps of sending at least one signal to the controller, via the at least one load cell, when the at least one load cell measures a pressure that is outside a range of predetermined pressures applied against the head; and retracting the head towards the apron and towards at least one cooling coil and a power coil, via the at least one head drive assembly, until a desired pressure is maintained between the head, the at least one cooling coil, and the power coil. This exemplary embodiment or another exemplary embodiment may further include steps of sending at least one signal to the controller, via the at least one load cell, when the at least one load cell of the head system measures a pressure that is outside a range of predetermined pressures applied against the head; and withdrawing the head away from at least one cooling coil and a power coil and away from the apron, via the at least one head drive assembly, until a desired pressure is maintained between the head, the at least one cooling coil, and the power coil. This exemplary embodiment or another exemplary embodiment may further include steps of engaging at least another head drive assembly with the head and the apron; providing at least another load cell with the head at a second position and with the at least another head drive assembly; and monitoring pressure applied to the head by the at least another load cell; wherein the second position is different than the first position. This exemplary embodiment or another exemplary embodiment may further include steps of sending at least one signal to the controller, via the at least one load cell or the at least another load cell, when the at least one load cell or the at least another load cell measures a first pressure that is outside a range of predetermined pressures applied against the head; and advancing the head towards the apron and towards at least one cooling coil and a power coil, via at least one of the at least one head drive assembly and the at least another head drive assembly, until a desired pressure is maintained between the head, the at least one cooling coil, and the power coil. This exemplary embodiment or another exemplary embodiment may further include steps of sending at least one signal to the controller, via the at least one load cell or the at least another load cell, when the at least one load cell or the at least another load cell measures a pressure that is outside a range of predetermined pressures applied against the head; and withdrawing the head away from the apron and away from the at least one cooling coil and the power coil, via at least one of the at least one head drive assembly and the at least another head drive assembly, until a desired pressure is maintained between the head, the at least one cooling coil, and the power coil. This exemplary embodiment or another exemplary embodiment may further include steps of sending at least one signal to the controller, via the at least one load cell, when the at least one load cell measures a first pressure that is outside a range of predetermined pressures applied against the head; sending at least another signal to the controller, via the at least another load cell, when the at least another load cell measures a second pressure that is outside the range of predetermined pressures applied against the head; and advancing the head towards the apron and towards the at least one cooling coil and the power coil, via the at least one head drive assembly and the at least another head drive assembly, until a desired pressure is maintained between the head, the at least one cooling coil, and the power coil. This exemplary embodiment or another exemplary embodiment may further include steps of sending at least one signal to the controller, via the at least one load cell, when the at least one load cell measures a first pressure that is outside a range of predetermined pressures applied against the head; sending at least another signal to the controller, via the at least another load cell, when the at least another load cell measures a second pressure that is outside the range of predetermined pressures applied against the head; and withdrawing the head away from the apron and away from the at least one cooling coil and the power coil, via at least one of the at least one head drive assembly and the at least another head drive assembly of the head system, until a desired pressure is maintained between the head, the at least one cooling coil, and the power coil.

In yet another aspect, an exemplary embodiment of the present disclosure may provide a method of monitoring pressure applied to a shunt and a head of an induction furnace during a melting process. The method includes steps of engaging at least one shunt drive assembly of a shunt system with a support column of the shunt system and the shunt of the shunt system; engaging at least one head drive assembly of a head system with an apron of the head system and the head of the head system; engaging at least one cooling coil of the induction furnace and a power coil of the induction furnace with the shunt; engaging the at least one cooling coil of the induction furnace with the head; providing at least one load cell with the shunt and with the at least one shunt drive assembly of the shunt system; providing at least another load cell with the head and with the at least one head drive assembly of the head system; connecting a controller of the induction furnace with the at least one load cell and the at least another load cell; connecting the controller with the at least one shunt drive assembly and the at least one head drive assembly; and monitoring pressure applied to the shunt and the head of the induction furnace during the melting process.

In yet another aspect, an exemplary embodiment of the present disclosure may provide a coreless induction furnace. The coreless induction furnace includes an outer shell. The coreless induction furnace also includes a set of adjustable shunt systems that operably engages with the outer shell. The coreless induction furnace also includes at least one cooling coil that operably engages with the set of adjustable shunt systems. The coreless induction furnace also includes a power coil that operably engages with the at least one cooling coil and the set of adjustable shunt systems; wherein the set of adjustable shunt systems is configured to automatically adjust at least one shunt of the set of adjustable shunt systems relative to at least one of the at least one cooling coil and the power coil.

This exemplary embodiment or another exemplary embodiment may further include that each adjustable shunt system of the adjustable shunt systems comprises: a support column operably engaged with the outer shell; and at least one shunt drive assembly operably engaged with the support column and the at least one shunt; wherein the shunt operably engages with the at least one cooling coil and the power coil; and wherein the at least one shunt drive assembly is configured to automatically adjust the shunt along an axis relative to the support column. This exemplary embodiment or another exemplary embodiment may further include that when the shunt is adjusted by the at least one shunt drive assembly, the at least one cooling coil and the power coil are adjusted with the shunt. This exemplary embodiment or another exemplary embodiment may further include that the at least one shunt drive assembly comprises: a first jack having a first end that operably engages with the shunt and a second end opposite to the first end; and a first motor operably engaged with jack; wherein the first motor is configured to linearly move the first jack and the shunt along the axis that is orthogonal to the support column. This exemplary embodiment or another exemplary embodiment may further include that each adjustable shunt system of the set of adjustable shunt systems further comprises: at least another shunt drive assembly operably engaged with the support column and the shunt; wherein the at least another shunt drive assembly is configured to automatically adjust the shunt along a second axis that is orthogonal to the support column and parallel with the axis of the at least one shunt drive assembly; and wherein each of the at least one shunt drive assembly and the at least another shunt drive assembly adjusts the shunt independently and separately from one another. This exemplary embodiment or another exemplary embodiment may further include that each adjustable shunt system of the set of adjustable shunt systems further comprises: a transition plate operably engaged with the shunt, the at least one cooling coil, and the power coil; wherein the transition plate is positioned between the shunt and the at least one cooling coil and the power coil such that the shunt is spaced apart from the at least one cooling coil and the power coil. This exemplary embodiment or another exemplary embodiment may further include that each adjustable shunt system of the set of adjustable shunt systems further comprises: a track operably engaged with the support column; and a sled assembly operably engaged with the track and operably engaged with the shunt at one of a first end of the shunt and a second end of the shunt opposite to the first end; wherein the sled assembly is configured to guide the shunt along the track. This exemplary embodiment or another exemplary embodiment may further include at least one load cell operably engaged with the shunt and the at least one shunt drive assembly of each adjustable shunt system of the set of adjustable shunt systems; and a controller electrically connected with the at least one load cell and the at least one shunt drive assembly of each adjustable shunt system of the set of adjustable shunt systems; wherein the controller is configured to automatically adjust the shunt, via the at least one shunt drive assembly, when the at least one load cell measures a pressure that is outside a range of predetermined pressures. This exemplary embodiment or another exemplary embodiment may further include at least one load cell operably engaged with the shunt and the at least one shunt drive assembly of each adjustable shunt system of the set of adjustable shunt systems; at least another load cell operably engaged with the shunt and the at least another shunt drive assembly of each adjustable shunt system of the set of adjustable shunt systems; and a controller electrically connected with the at least one load cell, the at least another load cell, the at least one shunt drive assembly, and the at least another shunt drive assembly; wherein the controller is configured to automatically adjust the shunt, via at least one of the at least one shunt drive assembly and the at least another shunt drive assembly, when at least one of the at least one load cell and the at least another load cell measures pressure that is outside a range of predetermined pressures.

This exemplary embodiment or another exemplary embodiment may further include an adjustable head system operably engaged with the outer shell; wherein the adjustable head system is configured to automatically adjust at least a head of the adjustable head system relative to the at least one cooling coil and the power coil; and wherein the set of adjustable shunt systems and the adjustable head system are automatically adjustable independently and separately from one another. This exemplary embodiment or another exemplary embodiment may further include that the adjustable head system comprises: a head; an apron operably engaged with the outer shell; and at least one head drive assembly operably engaged with the apron; wherein the at least one head drive assembly is configured to automatically adjust the head along an axis relative to the apron. This exemplary embodiment or another exemplary embodiment may further include that when the head is adjusted by the at least one head drive assembly, the at least one cooling coil and the power coil are adjusted with the head. This exemplary embodiment or another exemplary embodiment may further include that the at least one head drive assembly comprises: a first jack having a first end that operably engages with the head and a second end opposite to the first end; and a first motor operably engaged with jack; wherein the first motor is configured to linearly move the first jack and the head along the axis relative to the apron. This exemplary embodiment or another exemplary embodiment may further include that the adjustable head system further comprises: at least another head drive assembly operably engaged with the apron and the head; wherein the at least another head drive assembly is configured to automatically adjust the head along a second axis relative to the apron and parallel with the axis of the at least one head drive assembly; and wherein each of the at least one head drive assembly and the at least another head drive assembly adjusts the head independently and separately from one another. This exemplary embodiment or another exemplary embodiment may further include that the head of the adjustable head system further comprises: a top plate operably engaged with the at least one head drive assembly; and a refractory member operably engaged with the top plate and configured to engage with the at least one cooling coil to maintain a desired pressure on the at least one cooling coil and the power coil; wherein the top plate and the refractory member are adjustable relative to the apron and the at least one cooling coil. This exemplary embodiment or another exemplary embodiment may further include at least one load cell operably engaged with the head and the at least one head drive assembly; and a controller electrically connected with the at least one load cell and the at least one head drive assembly; wherein the controller is configured to automatically adjust the head, via the at least one head drive assembly, when the at least one load cell measures a pressure that is outside a range of predetermined pressures. This exemplary embodiment or another exemplary embodiment may further include at least one load cell operably engaged with the head and the at least one head drive assembly; at least another load cell operably engaged with the head and the at least another head drive assembly; and a controller electrically connected with the at least one load cell, the at least another load cell, the at least one head drive assembly, and the at least another head drive assembly; wherein the controller is configured to automatically adjust the shunt, via at least one of the at least one head drive assembly and the at least another head drive assembly, when at least one of the at least one load cell and the at least another load cell measure a pressure that is outside a range of predetermined pressures.

In yet another aspect, an exemplary embodiment of the present disclosure may provide a method of automatically adjusting one of a shunt of a shunt system and a head of a head system of a coreless induction furnace. The method includes steps of engaging the shunt system with an outer shell of the coreless induction furnace; engaging the head system with the outer shell of the coreless induction furnace; engaging at least one cooling coil of the coreless induction furnace with the shunt system and the head system; engaging a power coil of the coreless induction furnace with the shunt system and the at least one cooling coil; and automatically adjusting one of the shunt of the shunt system and a head of the head system of the coreless induction furnace.

This exemplary embodiment or another exemplary embodiment may further include that the steps of engaging the shunt system with the outer shell, the at least one cooling coil, and the power coil further comprises: engaging a support column of the shunt system with the outer shell; engaging at least one shunt drive assembly of the shunt system with the support column of the shunt system; engaging the at least one shunt drive assembly with the shunt of the shunt system; engaging the at least one cooling coil of the coreless induction furnace and the power coil of the coreless induction furnace with the shunt; and automatically adjusting the shunt of the shunt system of the coreless induction furnace, via the at least one shunt drive assembly, relative to the at least one cooling coil and the power coil. This exemplary embodiment or another exemplary embodiment may further include that steps of engaging the head system with the outer shell and the at least one cooling coil further comprises: engaging an apron of the shunt system with the outer shell; engaging at least one head drive assembly of the head system with the apron of the head system; engaging the at least one head drive assembly with the head of the head system; engaging at least one cooling coil of the coreless induction furnace with the head; and automatically adjusting the head of the head system of the coreless induction furnace, via the at least one head drive assembly, relative to the at least one cooling coil.

### BRIEF DESCRIPTION OF THE DRAWINGS

Sample embodiments of the present disclosure are set forth in the following description, are shown in the drawings and are particularly and distinctly pointed out and set forth in the appended claims.

FIG. 1 (FIG. 1) is a partial sectional view of an induction furnace in accordance with one aspect of the present disclosure, wherein the induction furnace includes adjustable shunt systems and an adjustable head system.

FIG. 2 (FIG. 2) is a top plan view of the induction furnace taken in the direction of line 2-2 shown in FIG. 1.

FIG. 3 (FIG. 3) is a sectional view of the induction furnace taken in the direction of line 3-3 shown in FIG. 1.

FIG. 4 (FIG. 4) is a sectional view of the induction furnace taken in the direction of line 4-4 shown in FIG. 1.

FIG. 4A (FIG. 4) is an enlarged view of the highlighted region shown in FIG. 4.

FIG. 5 (FIG. 5) is a partial isometric perspective view of at least one adjustable shunt system of the adjustable shunt systems of the induction furnace shown in FIG. 1.

FIG. 6 (FIG. 6) is a partial cross-sectional view taken in direction of line 6-6 shown in FIG. 5.

FIG. 7 (FIG. 7) is a partial isometric perspective view of at least one adjustable shunt system of the adjustable shunt systems of the induction furnace and the adjustable head system of the induction furnace shown in FIG. 1.

FIG. 8 (FIG. 8) is an enlarged view of the highlighted region shown in FIG. 1.

FIG. 9 (FIG. 9) is an enlarged view of the highlighted region shown in FIG. 1.

FIG. 10 (FIG. 10) is an operational view of the induction furnace during a melting process, wherein the head of the adjustable head system and a shunt of at least one adjustable system may be adjusted in response to pressure exerted on the head or the shunt.

FIG. 11A (FIG. 11A) is an exemplary flowchart of a set of instructions for a controller of induction furnace shown in FIG. 1.

FIG. 11B (FIG. 11B) is an exemplary flowchart of another set of instructions for a controller of induction furnace shown in FIG. 1.

FIG. 12A (FIG. 12A) is an exemplary flowchart of another set of instructions for a controller of induction furnace shown in FIG. 1.

FIG. 12B (FIG. 12B) is an exemplary flowchart of another set of instructions for a controller of induction furnace shown in FIG. 1.

FIG. 13 (FIG. 13) is an exemplary method flowchart.

FIG. 14 (FIG. 14) is another exemplary method flowchart.

FIG. 15 (FIG. 15) is another exemplary method flowchart.

FIG. 16 (FIG. 16) is another exemplary method flowchart.

FIG. 17 (FIG. 17) is another exemplary method flowchart.

FIG. 18 (FIG. 18) is another exemplary method flowchart.

Similar numbers refer to similar parts throughout the drawings.

### DETAILED DESCRIPTION

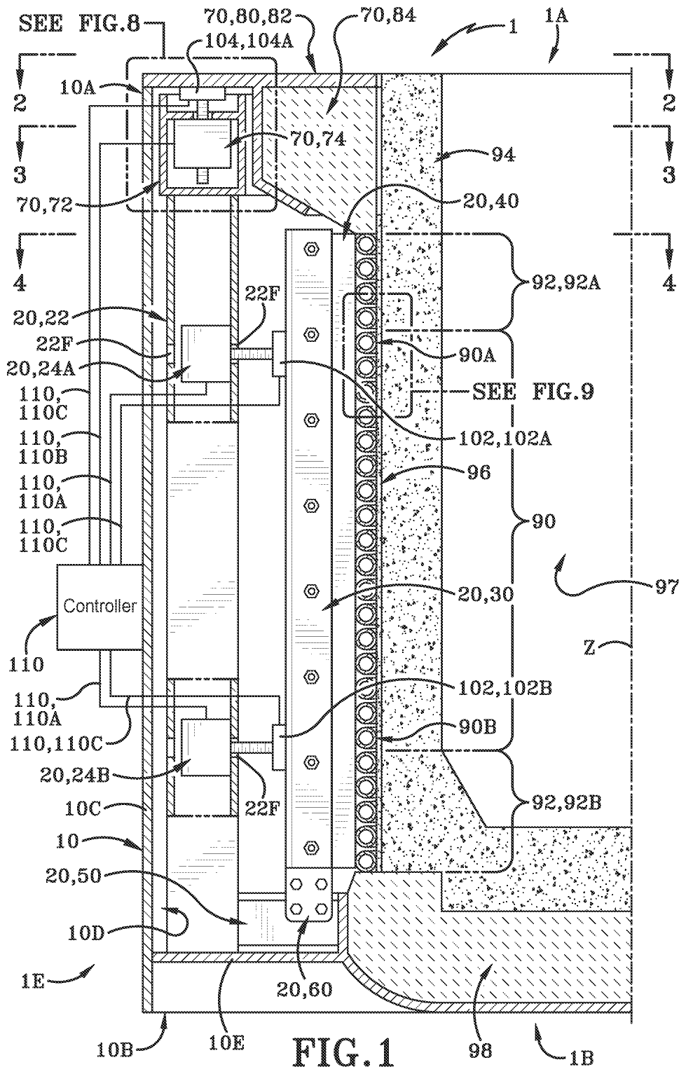

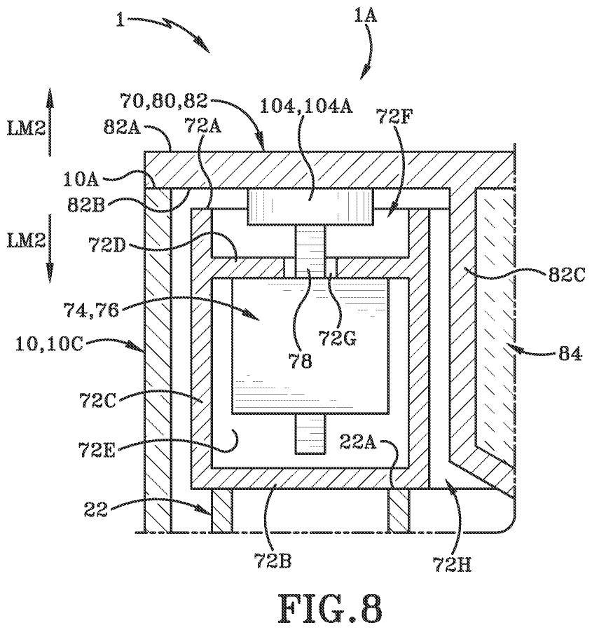

FIGS. 1-10 illustrate a coreless induction furnace or induction furnace, which is generally referred to as 1. It should be appreciated that induction furnace 1 may be configured to apply electrical energy to induce induction heating of various types of metals provided inside induction furnace 1. Induction furnace 1 described and illustrated herein, however, is configured to automatically adjust or move the positions of at least one shunt provided in induction furnace 1 and/or a head of induction furnace when assembling induction furnace 1, disassembling induction furnace 1, or when melting a metal material in induction furnace 1; such assemblies and/or components or adjusting at least one shunt and/or a head of induction furnace 1 are described in greater detail below.

It should be understood that while induction furnace 1 is a coreless induction furnace, such systems, assemblies, and components of induction furnace 1 may be included in other various types of induction furnaces, including channel induction furnaces and other various types of induction furnaces of the like.

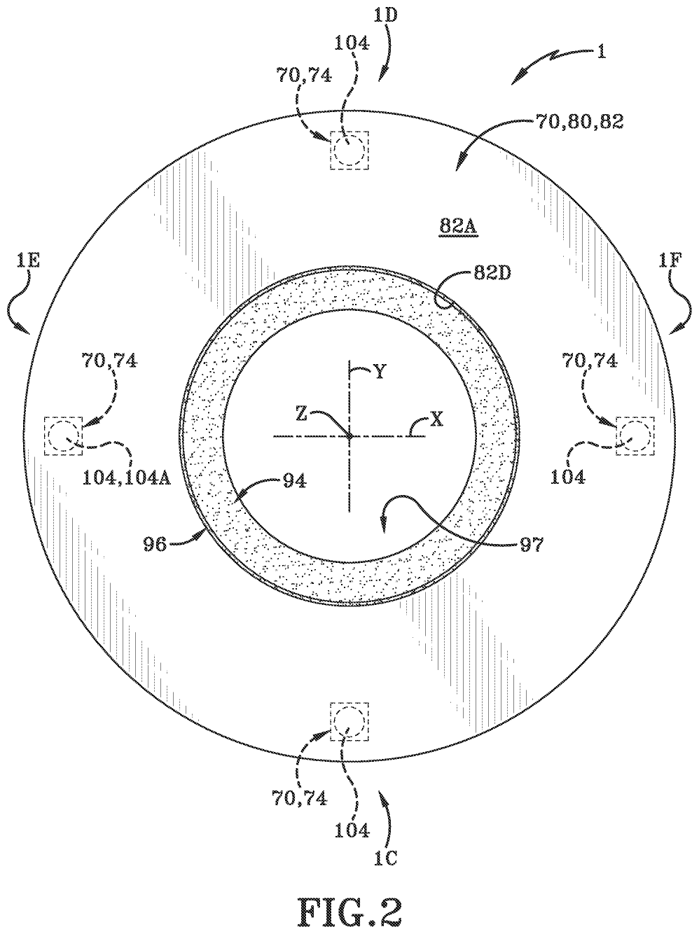

Induction furnace 1 may include a top end 1A, a bottom end 1B vertically opposite to top end 1A, and a vertical axis Z defined therebetween. Induction furnace 1 may also include a first or front side 1C, a second or rear side 1D longitudinally opposite to the front end 1C, and a longitudinal axis Y defined therebetween (see FIG. 2). Induction furnace 1 may also include a third or left side 1E, a fourth or right side 1F transversely opposite to left side 1E, and a transverse axis X defined therebetween.

Induction furnace 1 may include an outer shell or main support 10. Outer shell 10 is configured to be the main support mechanism and/or foundation of the assemblies and/or components housed inside of induction furnace 1. Outer shell 10 is also configured to be the final flux shield between a power coil of induction furnace 1 and the exterior environment surrounding the induction furnace 1 for preventing any stray flux from leaving the induction furnace during melting properties.

As best seen in FIG. 1, outer shell 10 may include a top end 10A, a bottom end 10B vertically opposite to top end 10A, and a vertical axis defined therebetween parallel with vertical axis Z. Outer shell 10 may also include a circumferential wall 10C that extends between top end 10A and bottom end 10B and defines a cylindrical-shape. Outer shell 10 may also define a chamber 10D by the circumferential wall 10C and extends between the top end 10A and the bottom end 10B. As best seen in FIG. 1, outer shell 10 may also include a base wall or support 10E that extends from the circumferential wall 10C and into the chamber 10D; such use and purpose of base wall 10E is described in more detail below.

It should be appreciated the outer shell 10 may be made from any suitable material that is configured to be the main support mechanism and/or foundation of the assemblies and/or components housed inside of induction furnace 1 as well as being the final flux shield between a power coil of induction furnace 1 and the exterior environment surrounding the induction furnace 1. In one exemplary embodiment, outer shell described and illustrated herein may be formed from a metal material, particularly steel or a similar metal material.

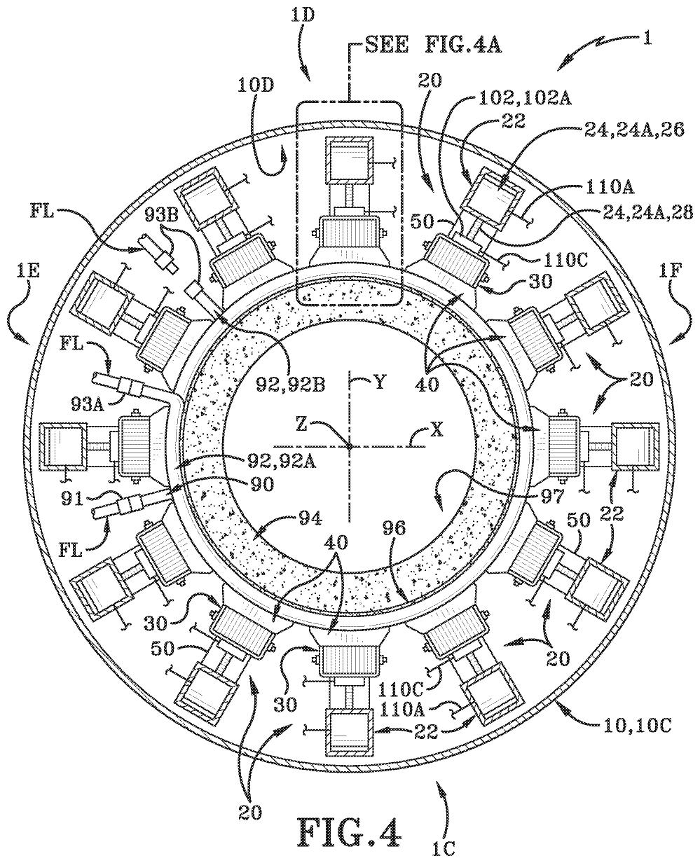

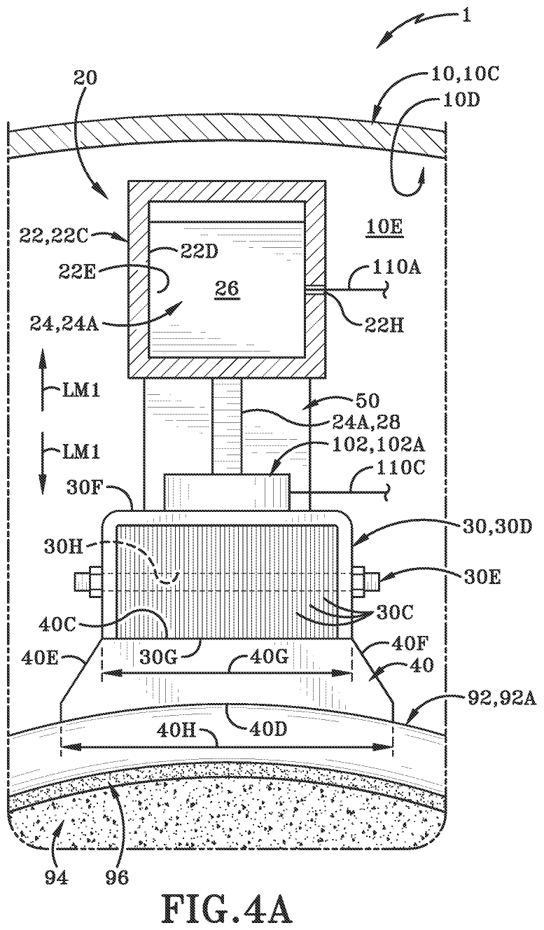

Induction furnace 1 may also include at least one adjustable shunt system 20 that operably engages with the outer shell 10 inside of chamber 10D. More particularly, the at least one adjustable shunt system 20 operably engages with base wall 10E of outer shell 10 inside of chamber 10D. In the illustrated embodiment, induction furnace 1 may include a plurality of adjustable shunt systems 20 that operably engages with the outer shell 10 inside of chamber 10D (see FIG. 4). In this illustrated embodiment, induction furnace 1 may include twelve adjustable shunt systems 20 that operably engages with the outer shell 10 inside of chamber 10D. In other exemplary embodiments, any suitable number of adjustable shunt systems may be provided in an induction furnace based on various considerations, include the size, shape, and configuration of the induction furnace. As described in more detail below, the shunt in each adjustable shunt system 20 of induction furnace 1 is configured to be automatically adjustable in response to pressure exerted on the shunt during assembly operations, disassembling operations, and melting processes. Such assemblies and components of each adjustable shunt system 20 are described in more detail below.

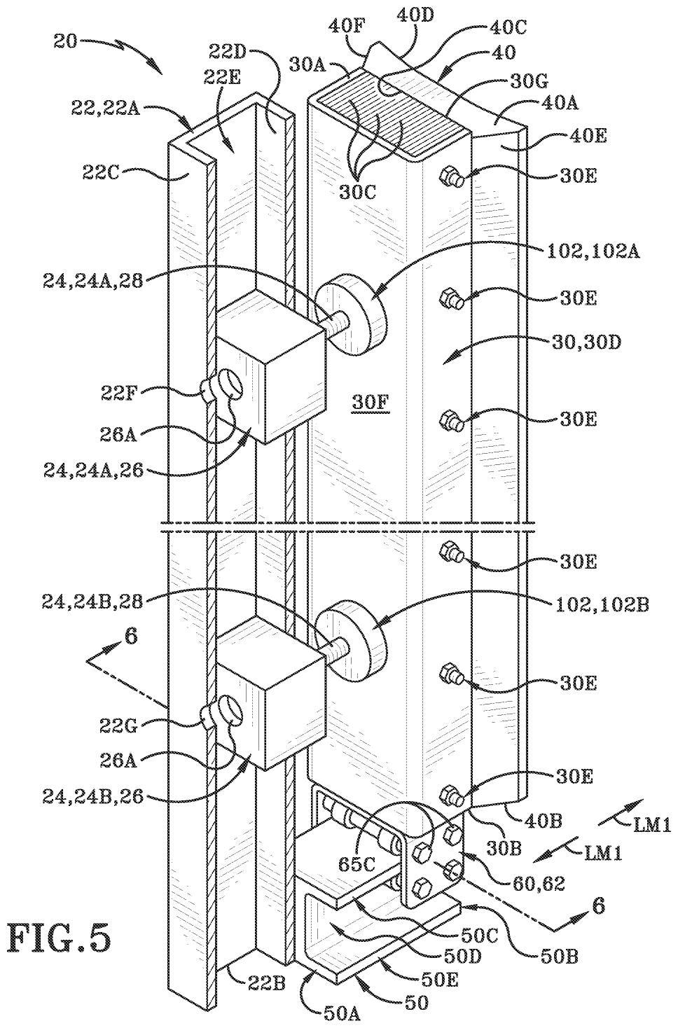

Each adjustable shunt system 20 may include a support column 22 that may operably engage with outer shell 10. More particularly, support column 22 may operably engage with the base wall 10E of outer shell 10 to maintain the support column 22 inside of chamber 10D of outer shell 10 (as shown in FIG. 1). As best seen in FIG. 1, support column 22 may include a top end 22A proximate to the top end 10A of outer shell 10, a bottom end 22B vertically opposite to the top end 22A and operably engaged with the base wall 10E, and a vertical axis defined therebetween parallel with vertical axis Z. Support column 22 may also include an outer surface 22C that extends between the top end 22A and the bottom end 22B (best seen in FIG. 5). Support column 22 may also include an inner surface 22D that extends between the top end 22A and the bottom end 22B; the inner surface 22D is positioned interior to the outer surface 22C and faces in an opposite direction away from the outer surface 22C. Support column 22 may also define a chamber 22E that is defined between the top end 22A and the bottom end 22B in which the inner surface 22D is positioned inside of chamber 22E. Such use and purpose of the chamber 22E defined by support column 22 is described in more detail below.

Support column 22 of each adjustable shunt system 20 may also define at least one pair of apertures where each aperture of the at least one pair of aperture are coaxial with one another. As best seen in FIGS. 1 and 5, support column 22 may define a first or upper pair of apertures 22F where each aperture of the upper pair of apertures 22F is coaxial with one another. Each aperture of the upper pair of apertures 22F also extends entirely through the support column 22 where the outer surface 22C and the inner surface 22D are in fluid communication with one another via the upper pair of apertures 22F. Similarly, support column 22 may define a second or lower pair of apertures 22G where each aperture of the lower pair of apertures 22G is coaxial with one another. Each aperture of the lower pair of apertures 22G also extends entirely through the support column 22 where the outer surface 22C and the inner surface 22D are in fluid communication with one another via the lower pair of apertures 22G. Such uses and purposes of the upper pair of apertures 22F and the lower pair of apertures 22G are described in more detail below.

Support column 22 may define a first side aperture 22H where first side aperture 22H is defined between the upper pair of apertures 22F. First side aperture 22H also extends entirely through the support column 22 where the outer surface 22C and the inner surface 22D are in fluid communication with one another via first side aperture 22H. While not illustrated herein, support column 22 may define a second side aperture (not illustrated) where second side aperture is defined between the lower pair of apertures 22G. Second side aperture also extends entirely through the support column 22 where the outer surface 22C and the inner surface 22D are in fluid communication with one another via second side aperture. Such uses and purposes of the first and second side apertures 22H are described in more detail below.

Each adjustable shunt system 20 may also include at least one shunt drive assembly 24 that operably engages with the support column 22. As described in more detail below, the at least one shunt drive assembly 24 in each adjustable shunt system 20 is configured to move a respective shunt in response to pressure applied against the shin during assembling operations of induction furnace 1, disassembling operations of induction furnace 1, or melting processes performed in induction furnace 1. The at least one shunt drive assembly 24 may also be operably engaged with the support column 22 inside of the chamber 22E. In the illustrated embodiment, each adjustable shunt system 20 of induction furnace 1 may include a first shunt drive assembly 24A and a second shunt drive assembly 24B that may be operably engaged with the support column 22 inside of the chamber 22E and are substantially similar to one another. It should be appreciated that while first shunt drive assembly 24A and second shunt drive assembly 24B are substantially similar to one another, first shunt drive assembly 24A will be described in more detail below for brevity. Inasmuch as the first shunt drive assembly 24A is be described, it should be appreciated that the description of the second shunt drive assembly 24B is substantially similar to the first shunt drive assembly 24A.

First shunt drive assembly 24A may include a motor 26 and a jack 28 that operably engages with the motor 26. As best seen in FIG. 5, motor 26 may define a passageway 26A that extends entirely through motor 26 to enable jack 28 to pass through motor 26 when motor 26 linearly moves jack 28 during operation. Referring to FIG. 1, jack 28 may include a first end 28A and a second end 28B longitudinally opposite to the first end 28A and operably engages with a shunt of adjustable shunt system 20, which is described in more detail below. Motor 26 may also be operably engaged with support column 22 inside of chamber 22E. More particularly, motor 26 may be operably engaged with the inner surface 22D of support column 22 inside of chamber 22E. In other exemplary embodiments, motor 26 may be operably engaged with support column 22 in various structural configurations such that the motor 26 is maintained with support column 22.

During operation, motor 26 is operable to linearly move the jack 28 inwardly and outwardly of support column 22 to automatically adjust a shunt of adjustable shunt system 20. Stated differently, motor 26 is operable to linearly move the jack 28 inwardly and outwardly of support column 22 along an axis that is orthogonal to the longitudinal axis of support column 22. Such linear movement of jack 28 by motor 26 is denoted by a double arrow labeled “LM1” in FIG. 4A. It should be appreciated that each aperture of the upper pair of apertures 22F is also sized and configured to enable the jack 28 to pass through the support column 22 when the motor 26 linearly moves the jack 28 inwardly and outwardly of support column 22.

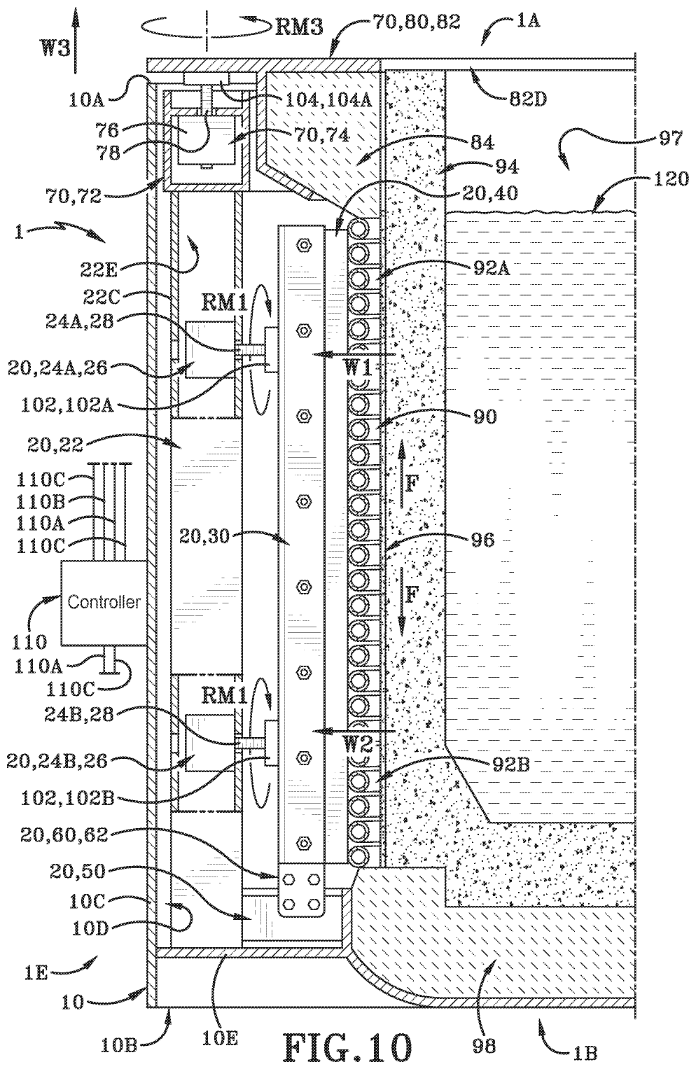

In the illustrated embodiment, first shunt drive assembly 24A is a motorized jackscrew mechanism for automatically adjusting a shunt of adjustable shunt system 20. In this illustrated embodiment, motor 26 is configured to rotate jack 28 about the longitudinal axis of jack 28 in order to linearly move the jack 28 inwardly and outwardly relative to support column 22; such rotational force applied to jack 28 via motor 26 is denoted by an arrow labeled “RM1” in FIG. 10. In other exemplary embodiments, any suitable mechanical mechanism and/or assembly may be used for automatically adjust a shunt of adjustable shunt system 20, including, electrical mechanisms, hydraulic mechanisms, or pneumatic mechanisms for automatically adjusting or moving a shunt in response to extreme pressure applied to the shunt.

As discussed previously, first shunt drive assembly 24A and second shunt drive assembly 24B operably engaged with the support column 22 inside of the chamber 22E and are substantially similar to one another. As such, motor 26 and jack 28 of second shunt drive assembly 24B are substantially similar to motor 26 and jack 28 of first shunt drive assembly 24A previously described above. It should also be appreciated that each aperture of the lower pair of apertures 22G is also sized and configured to enable the jack 28 of second shunt drive assembly 24B to pass through the support column 22 when the motor 26 of second shunt drive assembly 24B linearly moves the jack 28 inwardly and outwardly of support column 22.

Each adjustable shunt system 20 may also include a shunt 30 that operably engages with at least one shunt drive assembly 24. In the illustrated embodiment, shunt 30 of each adjustable shunt system 20 may operably engage with first shunt drive assembly 24A at a first position and with second shunt drive assembly 24B at a second position that is different than the first position. As described in more detailed below, shunt 30 is moveable and/or adjustable relative to the support column 22 along an axis that is orthogonal to the longitudinal axis of support column 22 by one or both of the first shunt drive assembly 24A and the second shunt drive assembly 24B in response to relieving pressure from the shunt 30 or applying pressure to the shunt 30; such operations of relieving pressure from shunt 30 and applying pressure to shunt 30 are described in more detail below.

As best seen in FIGS. 4A and 5, shunt 30 of each adjustable shunt system 20 may include a top end 30A proximate to top end 22A of support column 22, a bottom end 30B vertically opposite to top end 30A and proximate to bottom end 22B of support column 22, and a longitudinal axis defined therebetween parallel with vertical axis Z of induction furnace 1. Shunt 30 may also be formed by a series of laminate sheets 30C that is compressed together via a support bracket 30D. The series of laminate sheets 30C is also secured with the support bracket 30D via at least one securement mechanism 30E (e.g. a bolt threadably engaged with a nut). As best seen in FIGS. 4A and 5, shunt 30 may include a plurality of securement mechanisms 30E that secure the series of laminate sheets 30C with the support bracket 30D. It should be appreciated that while shunt 30 is described and illustrated herein with a particular structural configuration, any suitable, commercially available shunt or yoke may be used in each adjustable shunt system 20 of induction furnace 1 described and illustrated herein.

Upon assembly of each adjustable shunt system 20, at least one shunt drive assembly 24 may operably engage with the shunt 30 for automatically moving and/or adjusting the shunt 30 in response to relieving pressure from the shunt 30 or applying pressure to the shunt 30. More particularly, shunt 30 is moveable and/or adjustable relative to the support column 22 by one or both of the first shunt drive assembly 24A and the second shunt drive assembly 24B in response to relieving pressure from the shunt 30 or applying pressure to the shunt 30. Specifically, jacks 28 of the first shunt drive assembly 24A and the second shunt drive assembly 24B may be engaged with one or both of the series of laminate sheets 30C and the support bracket 30D for moving and/or adjusting the shunt 30 in response to relieving pressure from the shunt 30 or applying pressure to the shunt 30.

Still referring to FIGS. 4A and 5, shunt 30 may define a first side surface 30F extending along the entire length of shunt 30 between the top end 30A and the bottom end 30B. In the illustrated embodiment, first side surface 30F is substantially planar along the entire length of shunt 30 between the top end 30A and the bottom end 30B. Shunt 30 may also define a second side surface 30G extending along the entire length of shunt 30 between the top end 30A and the bottom end 30B. As best seen in FIGS. 4A and 5, second side surface 30G is also transversely opposite to the first side surface 30F, and the first side surface 30F and the second side surface 30G face in opposing directions. In the illustrated embodiment, second side surface 30G is also substantially planar along the entire length of shunt 30 between the top end 30A and the bottom end 30B. Such use of the first side surface 30F and the second side surface 30G being substantially planar surface is described in more detail below.

Referring to FIG. 4A, shunt 40 may also define sets of openings 30H that extend entirely through each laminate sheet of the series of laminate sheets 30C and support bracket 30D. With such sets of openings 30H, the bolts of the plurality of securement mechanisms 30E may pass through the series of laminate sheets 30C and support bracket 30D to hold the series of laminate sheets 30C and support bracket 30D with one another.

Induction furnace 1 may also include a transition plate 40 with each adjustable shunt system 20. As best seen in FIGS. 4A and 5, transition plate 40 of each adjustable shunt system 20 operably engages with the shunt 30 of each adjustable shunt system 20. Transition plate 40 may also be positioned between the shunt 30 of each adjustable shunt system 20 and one of both of at least one cooling coil of induction furnace 1 and a power coil of induction furnace 1, which are described in greater detail below. Such features and characteristics of transition plate 40 of each adjustable shunt system 20 are described in greater detail below.

As best seen in FIGS. 4A and 5, transition plate 40 may include a top end 40A proximate to top end 30A of shunt 30, a bottom end 40B vertically opposite to top end 40A and proximate to bottom end 30B of shunt 30, and a longitudinal axis defined therebetween parallel with vertical axis Z of induction furnace 1. Transition plate 40 may also define a first side surface 40C extending along the entire length of transition plate 40 between the top end 40A and the bottom end 40B. In the illustrated embodiment, first side surface 40C is substantially planar along the entire length of transition plate 40 between the top end 40A and the bottom end 40B. Transition plate 40 may also define a second side surface 40D extending along the entire length of transition plate 40 between the top end 40A and the bottom end 40B. As best seen in FIGS. 4A and 5, second side surface 40D is also transversely opposite to the first side surface 40C, and the first side surface 40C and the second side surface 40D face in opposing directions. In the illustrated embodiment, second side surface 40D is curvilinear-shaped or is concavely-shaped along the entire length of transition plate 40 between the top end 40A and the bottom end 40B.

Transition plate 40 may also include a third side surface 40E and a fourth side surface 40F opposite to the third side surface 40E. As best seen in FIGS. 4A-5, third side surface 40E may extend between top end 40A and bottom end 40B and positioned intermediate the first side surface 40C and the second side surface 40D. Still referring to FIGS. 4A-5, fourth side surface 40F may also extend between top end 40A and bottom end 40B and positioned intermediate the first side surface 40C and the second side surface 40D opposite to the third side surface 40E. As best seen in FIG. 4A, first side surface 40C may define a first width 40G that is measured between the third side surface 40E and the fourth side surface 40F. Similarly, second side surface 40D may also define a second width 40H that is measured between the third side surface 40E and the fourth side surface 40F where the second width 40H is greater than the first width 40G.

In other exemplary embodiments, first side surface 40C and second side surface 40D may define any suitable widths based on the structure configuration of transition plate 40. In one exemplary embodiment, first width 40G of first side surface 40C may be greater than second width 40H of second side surface 40D. In another exemplary embodiment, first width 40G of first side surface 40C may be equal with second width 40H of second side surface 40D.

Upon assembly of induction furnace 1, transition plate 40 is configured to engage with the respective shunt in each adjustable shunt system 20 while engaging with one of both of at least one cooling coil of induction furnace 1 and a power coil of induction furnace 1. As best seen in FIGS. 4A and 5, the first side surface 40C of the transition plate 40 directly contacts and engages with the second side surface 30G of shunt 30, and the second side surface 40D of the transition plate 40 engages with one or both of at least one cooling coil of induction furnace 1 and a power coil of induction furnace 1. As such, the transition plate 40 of each adjustable shunt system 20 is positioned between the shunt 30 of each adjustable shunt system 20 and one of both of at least one cooling coil of induction furnace 1 and a power coil of induction furnace 1.

The structural configuration and positioning of the transition plate 40 in each adjustable shunt system 20 is considered advantageous at least because the transition plate 40 promotes uniform and even pressure to be applied to at least one cooling coil of induction furnace 1 and a power coil of induction furnace 1 via the shunt 30. In the illustrated embodiment, the engagement between the planar surface 30G of shunt 30 and planar surface 40C of transition plate 40 enables uniform and even pressure to be transferred between shunt 30 and transition plate 40 when pressured is applied by shunt 30, via one or both of the first and second shunt drive assemblies 24A, 24B, or is applied by transition plate 40 via a power coil of induction furnace 1.

The structural configuration and positioning of the transition plate 40 in each adjustable shunt system 20 is also considered advantageous at least because the transition plate 40 may enable the shunt 30 to provide greater force and/or pressure on at least one cooling coil of induction furnace 1 and a power coil of induction furnace 1 by providing leverage on the transition plate 40 via the shunt 30. Moreover, such structural configuration and positioning of the transition plate 40 may prevent warpage and/or deterioration of shunt 30 when a power coil of induction furnace 1 exerts force during melting operations. Such force exerted by a power coil of induction furnace 1 will be applied to the curvilinear shape of transition plate 40 (i.e., second side surface 40D), which matches and/or is complementary with the shape a power coil of induction furnace 1. As such, shunt 30 of each adjustable shunt system 20 is isolated from a power coil of induction furnace 1 such that transition plate 40 of each adjustable shunt system 20 acts a barrier or absorber of pressure exerted by the power coil of induction furnace 1.

Since transition plate 40 of each adjustable shunt system 20 engages with a power coil of induction furnace 1, transition plate 40 of each adjustable shunt system 20 may be made from any suitable material to withstand high level of electrical current and force from a power coil along with extreme heat emitted from the molten charge melting inside of induction furnace 1 during melting processes. More particularly, transition plate 40 of each adjustable shunt system 20 may be formed from a composite material for withstanding high level of electrical current and force from a power coil along with extreme heat emitted from the molten charge melting inside of induction furnace 1 during melting processes. Specifically, transition plate 40 of each adjustable shunt system 20 may be formed from a high-pressure fiberglass laminate, such as G-10 or garolite, for withstanding high level of electrical current and force from a power coil along with extreme heat emitted from the molten charge melting inside of induction furnace 1 during melting processes.

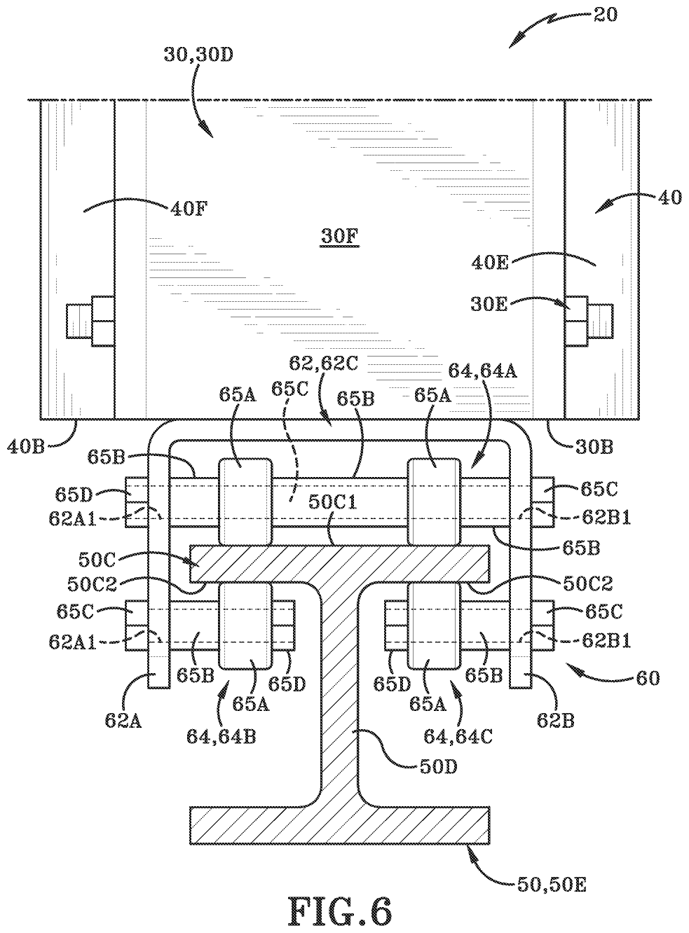

Each adjustable shunt system 20 may also include a track 50 and a sled assembly that slidably engages with the track 50. As best seen in FIGS. 5 and 6, track 50 of each adjustable shunt system 20 may operably engage with the outer shell 10 inside of chamber 10D, particularly with the base wall 10E of outer shell 10. Optionally, track 50 of each adjustable shunt system 20 may also operably engage with the support column 22 of each adjustable shunt system 20 while also being engaged with the outer shell 10. Still referring to FIGS. 5 and 6, sled assembly 60 of each adjustable shunt system 20 may also operably engage with the shunt 30 where the shunt 30 may be guided along the track 50 by assistance of sled assembly 60. Such features of track 50 along with components of sled assembly 60 are described in further detail below.

As best seen in FIGS. 5 and 6, track 50 of each adjustable shunt system 20 may include a first end 50A proximate to the support column 22, a second end 50B longitudinally opposite to the first end 50A and remote from support column 22, and a longitudinal axis defined therebetween. Track 50 may also include an upper horizontal wall 50C that extends longitudinally between the first end 50A and the second end 50B. Upper horizontal wall 50C may define a top surface 50C1 and a bottom surface 50C2 vertically opposite to the top surface 50C1 and facing away from the top surface 50C1. Track 50 may also include a vertical wall 50D that extends orthogonally from the upper horizontal wall 50C, particularly at the bottom surface 50C2, and along an axis that is orthogonal to the longitudinal axis of track 50. Track 50 may also include a lower horizontal wall 50E that operably engages with the vertical wall 50D. Similar to upper horizontal wall 50C, lower horizontal wall 50E also extends longitudinally between the first end 50A and the second end 50B such that the upper horizontal wall 50C and the lower horizontal wall 50E are parallel with one another and is orthogonal with the vertical wall 50D. With such configuration, track 50 may define a l-shaped cross section where track 50 may be an I-beam member.

Still referring to FIGS. 5 and 6, sled assembly 60 may include a frame 62. Frame 62 includes a first upright wall 62A, a second upright wall 62B positioned opposite to the first upright wall 62A, and a connecting wall 62C operably engaged with the first upright wall 62A and the second upright wall 62B where the connecting wall 62C is positioned between the first upright wall 62A and the second upright wall 62B. First upright wall 62A may also define a first set of openings 62A1 where each opening of the first set of openings 62A1 extends entirely through the first upright wall 62A along an axis that is parallel with the connecting wall 62C. Similarly, second upright wall 62B may also define a second set of openings 62B1 where each opening of the second set of openings 62B1 extends entirely through the second upright wall 62B along an axis that is parallel with the connecting wall 62C. It should be appreciated that the first set of openings 62A1 and the second set of openings 62B1 are coaxial with one another. With such configuration, sled assembly 60 may define a U-shaped cross section that may partially house the track 50 inside of the frame 62 (best seen in FIG. 6). More particularly, upper horizontal wall 50C and a portion of vertical wall 50D may be housed inside of frame 62.

Still referring to FIGS. 5 and 6, sled assembly 60 may also include at least one roller assembly that operably engages with the frame 62 to slidably move and guide the frame 62 and the shunt 30 along the track 50. In the illustrated embodiment, sled assembly 60 includes a set of roller assemblies 64 that operably engages with the frame 62 to slidably move and guide the frame 62 and the shunt 30 along the track 50; such sliding engagement and movement of the sled assembly 60 along track 50 is denoted by a double arrow labeled “SE” in FIG. 5. Each roller assembly of the set of roller assemblies 64 may include at least one roller or wheel 65A, at least one spacer sleeve 65B operably engaged between one of the first upright wall 62A and the second upright wall 62C and the at least one wheel 65A, and a bolt 65C threadably engaged with a nut 65D for securing the at least one wheel 65A and the at least one spacer sleeve 65B with the frame 62. Bolt 65C is also operably engaged with the frame 62 and configured to enable the at least one wheel 65A to rotate about a longitudinal axis of the bolt 65C. As best seen in FIG. 6, bolt 65C of each roller assembly of the set of roller assemblies 64 may pass through one of the openings in the first set of openings 62A1 defined in the first upright wall 62A or in the second set of openings 62B1 defined in the second upright wall 62B.

It should be appreciated that any suitable number of roller assemblies from the set of roller assemblies 64 may slidably engage with the track 50. In one example, at least one roller assembly of the set of roller assemblies 64 may slidably engage with the top surface 50C1 of upper horizontal wall 50C of track 50, and at least another roller assembly of the set of roller assemblies 64 may slidably engage with the bottom surface 50C2 of upper horizontal wall 50C of track 50. In another example, a first group of roller assemblies 64A may slidably engage with the top surface 50C1 of upper horizontal wall 50C of track 50, a second group of roller assemblies 64B may slidably engage with the bottom surface 50C2 of upper horizontal wall 50C of track 50 and operably engage with the first upright wall 62A, and a third group of roller assemblies 64C may slidably engage with the bottom surface 50C2 of upper horizontal wall 50C of track 50 and operably engage with the second upright wall 62B (see FIG. 6).

It should also be appreciated that track 50 and sled assembly 60 may be positioned at any suitable location relative to shunt 30 while still being able to slidably move and guide the shunt 30 along track 50. In one instance, track 50 and sled assembly 60 may be positioned vertically above the shunt 30 such that the track 50 is vertically above the top end 30A of shunt 30 and the sled assembly 60 is operably engaged at the top end 30A of shunt 30. In another instance, track 50 and sled assembly 60 may be positioned vertically below the shunt 30 such that the track 50 is vertically below the bottom end 30B of shunt 30 and the sled assembly 60 is operably engaged at the bottom end 30B of shunt 30 (see FIGS. 5 and 6). In yet another instance, track 50 and sled assembly 60 may be positioned between the top end 30A and the bottom end 30B of the shunt 30 such that the track 50 is positioned between the top end 30A and the bottom end 30B of the shunt 30 and the sled assembly 60 is operably engaged with the shunt 30 at a position between the top end 30A and the bottom end 30B of the shunt 30.

While not illustrated herein, sled assembly 60 may be configured with a housing that holds and seals devices and/or components for powering electrical components provided in induction furnace 1, including shunt adjust assemblies 24A, 24B. As such, the housing would translate and/or move with shunt 30 during assembly operations of induction furnace 1, disassembly operations of induction furnace 1, and melting processes performed by induction furnace 1.

Induction furnace 1 may also include an adjustable head system 70 that operably engages with the outer shell 10. During operation, adjustable head system 70 may be configured to automatically adjust a head of adjustable head system 70 to maintain at least one cooling coil of induction furnace 1 and a power coil of induction furnace 1 at a desired pressure when assembling induction furnace 1, dissembling induction furnace 1, and melting a molten charge inside of induction furnace 1. It should be appreciated that adjustable head system 70 may also be configured to automatically adjust a head of the adjustable head system 70 separately and independently from each adjustable shunt system 20 automatically adjust a shunt 30 in response to pressure exerted on head of adjustable head system 70 or shunt 30 of any of the adjustable shunt systems 20. Such component and assemblies of adjustable head system 70 are described in more detail below.

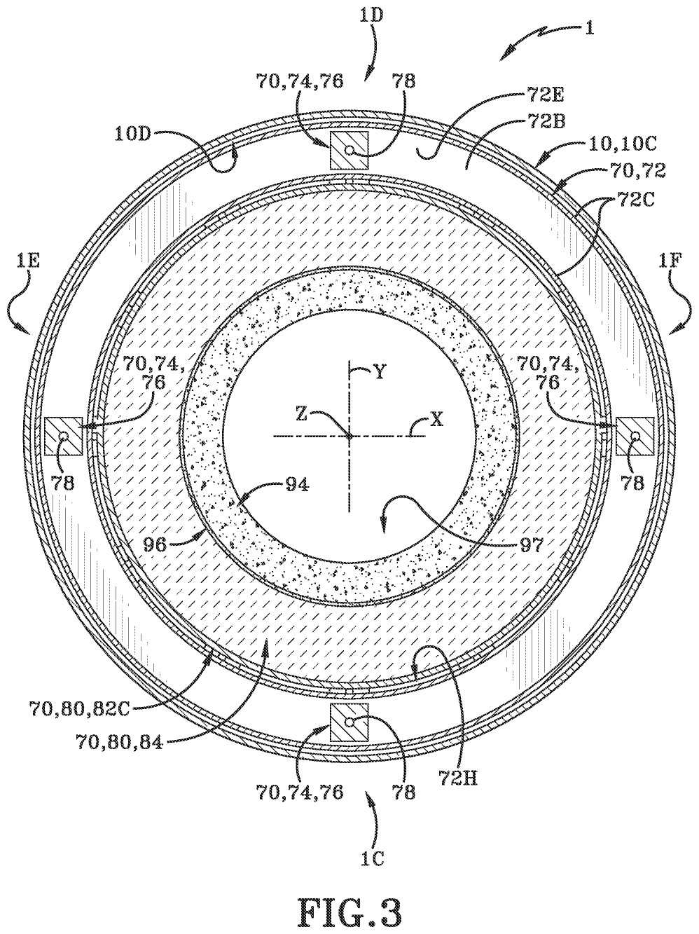

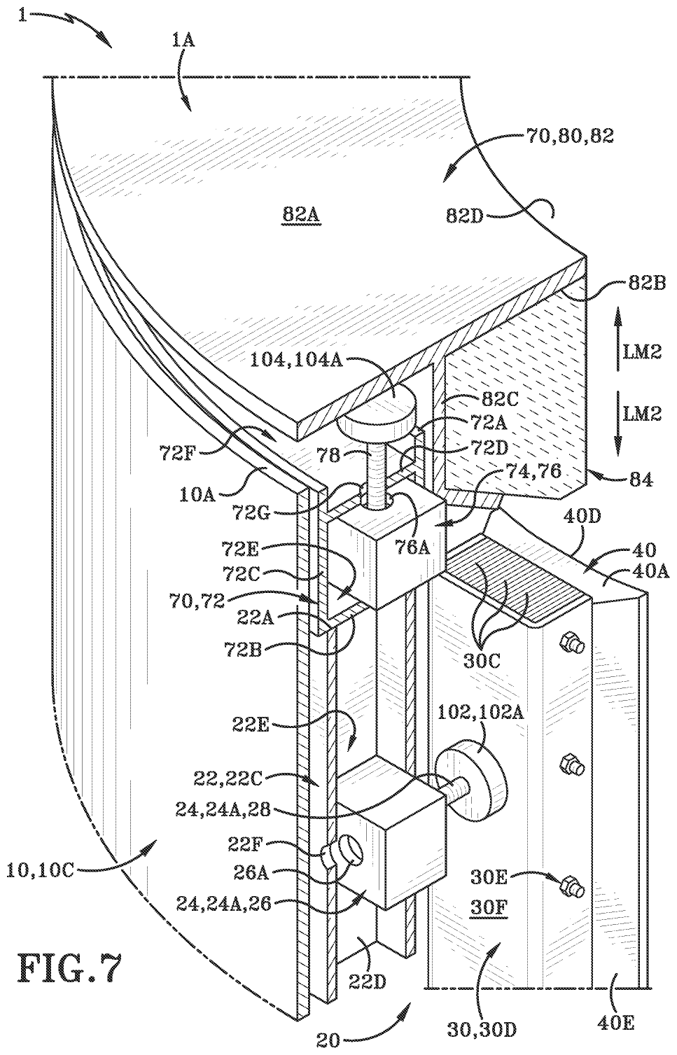

Adjustable head system 70 may include an apron 72 that operably engages with the adjustable shunt systems 20. As best seen in FIG. 3, apron 72 may define be annular-shaped such that the apron 72 matches with the overall shape of outer shell 10. As best seen in FIGS. 1 and 7, apron 72 may operably engage with the support columns 22 of adjustable shunt systems 20. Apron 72 may include a top end 72A positioned remote from support columns 22, a bottom end 72B positioned vertically opposite to the top end 72A, and a surrounding wall 72C defining a U-shaped cross section that extends between the top end 72A and the bottom end 72B and operably engages with the support columns 22. Apron 72 may also include a cross member 72D that operably engages with the surrounding wall 72C between the top end 72A and the bottom end 72B. Apron 72 may also define a chamber 72E between the surrounding wall 72C and the cross member 72D. Apron 72 may also define a recess 72F that extends downwardly from the top end 72A to the cross member 72D. Apron 72 may also define a set of openings 72G in the cross member 72D that provide fluid communication between the chamber 72E and the recess 72F; such use of this set of openings 72G is described in more detail below.

Apron 72 may also define a central opening 72H, via the surrounding wall 72C, that extends entirely through the apron 72 and is interior of the surrounding wall 72C. It should be appreciated that chamber 72E and central opening 72H are separate and spaced apart from one another via the surrounding wall 72C. It should be appreciated that recess 72F and central opening 72H are separate and spaced apart from one another via the surrounding wall 72C.

Adjustable head system 70 may also include at least one head drive assembly 74 that operably engages with the apron 72. As best seen in FIG. 7, the at least one head drive assembly 74 operably engages with the apron 72 inside of the chamber 72E. More particularly, the at least one head drive assembly 74 operably engages with the cross member 72D of apron 72 inside of the chamber 72E. In the illustrated embodiment, adjustable head system 70 includes a set of head drive assemblies 74 where each head drive assembly 74 operably engages with the apron 72 inside of the chamber 72E, more particularly with the cross member 72D of apron 72 inside of the chamber 72E. Such components of each head drive assembly in the set of head drive assemblies 74 are described in greater detail below.

As best seen in FIG. 7, each head drive assembly 74 may include a motor 76 and a jack 78 that operably engages with the motor 76. As best seen in FIG. 7, motor 76 may define a chamber 76A that extends into motor 26 to enable jack 78 to pass in and out of motor 76 when motor 76 linearly moves jack 78 during operation. Referring to FIG. 7, jack 28 may include a first end 78A and a second end 78B longitudinally opposite to the first end 78A and operably engages with a head of adjustable head system 70, which is described in more detail below. Motor 76 may also be operably engaged with apron 72 inside of chamber 72E. More particularly, motor 76 may be operably engaged with the cross member 72D of apron 72 inside of chamber 72E. In other exemplary embodiments, motor 76 may be operably engaged with apron 72 in various structural configurations such that the motor 76 is maintained with apron 72.

During operation, motor 76 is operable to linearly move the jack 78 inwardly and outwardly of apron 72 to automatically adjust a head of adjustable head system 70. Stated differently, motor 76 is operable to linearly move the jack 78 inwardly and outwardly of apron 72 along an axis that is orthogonal to the longitudinal axis of apron 72. Such linear movement of jack 78 by motor 76 is denoted by a double arrow labeled “LM2” in FIG. 7. It should be appreciated that each opening of the set of openings 72G is also sized and configured to enable the jack 78 to pass through the apron 72 when the motor 76 linearly moves the jack 78 inwardly and outwardly of apron 72.

In this illustrated embodiment, motor 76 is configured to rotate jack 78 about the longitudinal axis of jack 78 in order to linearly move the jack 78 inwardly and outwardly relative to apron 72; such rotational force applied to jack 78 via motor 76 is denoted by an arrow labeled “RM2” in FIG. 10. In other exemplary embodiments, any suitable mechanical mechanism and/or assembly may be used for automatically adjust a head of adjustable head system 70, including, electrical mechanisms, hydraulic mechanisms, or pneumatic mechanisms for automatically adjusting or moving a head in response to extreme pressure applied to the head.

Adjustable head system 70 may also include a head 80 that operably engages with the set of head drive assemblies 74. As described in more detailed below, head 80 is also moveable and/or adjustable relative to the apron 72 along an axis that is orthogonal to the longitudinal axis of apron by at least one of head drive assemblies 74 in response to relieving pressure from head 80 or applying pressure to head 80.

As best seen in FIG. 7, head 80 may include a top plate 82 that operably engages with the set of head drive assemblies 74. More particularly, top plate 82 operably engages with the jacks 78 of the set of head drive assemblies 74. Top plate 82 may include a top surface 82A facing away from chamber 10D, a bottom surface 82B vertically opposite to the top surface 82A and facing into chamber 10D, and a retaining arm 82C extending from the bottom surface 82B and into the chamber 10D. Head 80 may also include a refractory member 84 that operably engages with the top plate 82 via the retaining arm 82C. It should be appreciated that refractory member 84 may operably engage with at least one cooling coil of induction furnace 1 to maintain a desired pressure on at least one cooling coil of induction furnace 1 as well as a power coil of induction furnace 1. Such engagement of the head 80 with at least one cooling coil of induction furnace 1 as well as a power coil of induction furnace 1 is described in more detail below.

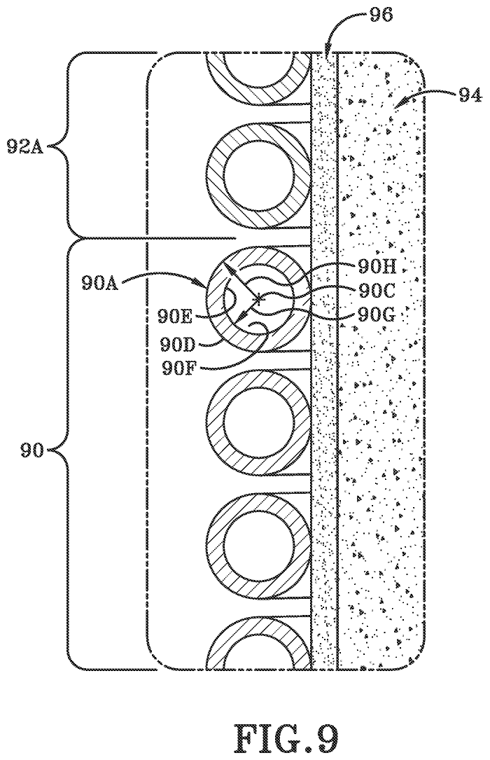

Induction furnace 1 may also include a power coil 90. As best seen in FIG. 4A, power coil 90 directly contacts and operably engages with transition plates 40 of adjustable shunt systems 20 inside of induction furnace 1. As best seen in FIG. 9, power coil 90 may include a first end 90A, a second end 90B opposite to the first end 90A (see FIG. 1), and a lengthwise axis 90C defined therebetween. As best seen in FIG. 9, power coil 90 may also include an outer circumferential wall 90D that extends between the first end 90A and the second end 90B. Power coil may also include an inner circumferential wall 90E that extends between the first end 90A and the second end 90B. In the illustrated embodiment, inner circumferential wall 90E is positioned interior to the outer circumferential wall 90D and is spaced apart and separate from the outer circumferential wall 90D. Inner circumferential wall 90E also defines a passageway 90F that extends between the first end 90A and the second end 90B for allowing a continuous stream of cooling fluid (e.g., water or other conventional cooling fluids of the like) to flow through the power coil 90 for cooling means.

Referring to FIG. 9, power coil 90 may define an inner radius 90G that is measured from the lengthwise axis 90C to the inner circumferential wall 90E. Power coil 90 may also define an outer radius 90H that is measured from the lengthwise axis 90C to the outer circumferential wall 90D. With such radii 90G, 90H, power coil 90 may define a curvilinear and/or round cross-sectional shape along the entire length of power coil 90 between the first end 90A and the second end 90B. Such circular cross-sectional shape defined in power coil 90 may allow for a greater length of power coil 90 to be wound inside of induction furnace 1 as compared to conventional power coils that define a square or rectangular cross-sectional shape. Due to the implantation of the adjustable shunt systems 20 described and illustrated herein, power coil 90 may define a circular cross-sectional shape based on the structural arrangement and engagement between the power coil 90 and the transition plates 40 of adjustable shunt systems 20.

As described in more detail below, such structural arrangement and engagement between power coil 90, adjustable shunt systems 20, and adjustable head system 70 enables users of induction furnace 1 to quickly remove and install a new power coil 90 than conventional methods and techniques in the art. Due to the rapid and automatic disassembly and reassembly of the induction furnace 1 via adjustable shunt systems 20 and adjustable head system 70, power coil 90 no longer needs to be repaired inside of the induction furnace 1 as compared to conventional maintenance methods and techniques used in the art. With such ease of removing and replacing the used power coil 90 with a new power coil 90, the used power coil 90 may be repaired offsite under optimal repair conditions.

It should be appreciated that power coil 90 is configured to connect with any suitable electrical power source that is conventionally used in the art for carrying alternating current and generating an electromagnetic field inside of induction furnace 1 to melt suitable metals. In one exemplary embodiment, power coil 90 may be formed from a high electrical conductivity oxygen free copper tubing for carrying alternating current and generating an electromagnetic field inside of induction furnace 1 to melt suitable metals.

Induction furnace 1 may also include at least quick disconnect mechanism 91 for releasably attaching or connecting at least one inlet fluid supply line “FL” to power coil 90. As best seen in FIG. 4, the at least one quick disconnect mechanism 91 may be operably engaged with the first end 90A of power coil 90 to deliver cooling fluid to power coil 90, and at least another quick disconnect mechanism (not illustrated herein) may be operably engaged with the second end 90B of power coil 90 to return used cooling fluid to a cooling fluid source or tower (not illustrated herein) and away from the induction furnace 1. Such use of quick disconnect mechanisms 91 is considered advantageous at least because the quick disconnect mechanisms 91 enables the induction furnace 1 to be completely isolated from a cooling fluid source and/or a main cooling fluid system. With such isolation from cooling fluid source and/or a main cooling fluid system, cooling fluid trapped inside of power coil 90 may be easily blown out and emptied when the quick disconnect mechanisms 91 are releasably detached from the power coil 90; such structural configuration is considered advantageous at least because power coil 90 may remain inside of the induction furnace 1 when cooling fluid is emptied from power coil 90.

Induction furnace 1 may also include at least one cooling coil 92 that is positioned one of vertically above power coil 90 and vertically below power coil 90. In the illustrated embodiment, induction furnace 1 may include an upper cooling coil 92A positioned vertically above power coil 90 near the first end 90A of power coil 90. In this same illustrated embodiment, induction furnace 1 may also include a lower cooling coil 92B positioned vertically below power coil 90 near the second end 90B of power coil 90. As such, upper cooling coil 92A and lower cooling coil 92B are separated and spaced apart from one another by power coil 90. As best seen in FIGS. 1 and 9, upper cooling coil 92A and lower cooling coil 92B may also define similar radii and a similar curvilinear and/or round cross-sectional shape similar to the radii and curvilinear cross-sectional shape defined by power coil 90. In other exemplary embodiment, upper cooling coil 92A and lower cooling coil 92B may define radii that differ from radii 90G, 90H defined by power coil 90 as well as defining a cross-sectional shape that differs from the cross-sectional shape define by power coil 90.

Induction furnace 1 may also include at least set of quick disconnect mechanism 93 for releasably attaching or connecting at least one inlet fluid supply line “FL” to upper cooling coal 92A and lower cooling coil 92B. As best seen in FIG. 4, a first set of quick disconnect mechanism 93A may be operably engaged with the upper cooling coil 92A to deliver cooling fluid to the upper cooling coil 92A, and at least another quick disconnect mechanism 93B may be operably engaged with the lower cooling coil 92B to deliver cooling fluid to the lower cooling coil 92B. Such use of quick disconnect mechanisms 93A, 93B is considered advantageous at least because the quick disconnect mechanisms 93A, 93B enables the induction furnace 1 to be completely isolated from a cooling fluid source and/or a main cooling fluid system. With such isolation from cooling fluid source and/or a main cooling fluid system, cooling fluid trapped inside of the upper cooling coil 92A and the lower cooling coil 92B may be easily blown out and emptied when the quick disconnect mechanisms 93A, 93B are releasably detached from t the upper cooling coil 92A and the lower cooling coil 92B; such structural configuration is considered advantageous at least because upper cooling coil 92A and the lower cooling coil 92B to remain inside of the induction furnace 1 when cooling fluid is emptied from the upper cooling coil 92A and the lower cooling coil 92B.

Induction furnace 1 may also include a refractory liner or crucible 94 that operably engages with the power coil 90 as well as the upper cooling coil 92A and the lower cooling coil 92B (see FIG. 1). Induction furnace 1 may also include grouting 96 that is positioned between the refractory liner 94 and the power coil 90, upper cooling coil 92A, and lower coiling coil 92B. In other exemplary embodiments, grouting 96 may be omitted from induction furnace 1 if so desired. Induction furnace 1 may also include a bowl refractory 98 that is positioned vertically below the power coil 90, upper cooling coil 92A, and lower coiling coil 92B as well as the refractor liner 94. As illustrated herein, power coil 90, upper cooling coil 92A, and lower coiling coil 92B may also operably engage with bowl refractory 98 given lower cooling coil 92B rests on the bowl refractory 98. Bowl refractory 98 may also operably engage with the outer shell 10, particularly, the base wall 10E of outer shell 10.

Induction furnace 1 may also include at least one set of load cells provided in one or both of adjustable shunt systems 20 and adjustable head system 70. As best seen in FIGS. 1, 5, and 7, induction furnace 1 may include a first set of load cells 102 that operably engages with each shunt 30 of the adjustable shunt systems 20. In one instance, as seen in FIG. 5, a first load cell 102A of the first set of load cells 102 may be operably engaged with the first shunt drive assembly 24A and the shunt 30. Continuing with this instance, first load cell 102A of the first set of load cells 102 may be operably engaged with the jack 28 of the first shunt drive assembly 24A and the shunt 30 such that the first load cell 102A is positioned between the jack 28 of the first shunt drive assembly 24A and the shunt 30. In another instance, as seen in FIG. 5, a second load cell 102B of the first set of load cells 102 may be operably engaged with the second shunt drive assembly 24B and the shunt 30. Continuing with this instance, second load cell 102B of the first set of load cells 102 may be operably engaged with the jack 28 of the second shunt drive assembly 24B and the shunt 30 such that the second load cell 102B is positioned between the jack 28 of the second shunt drive assembly 24B and the shunt 30.

During operation, first set of load cells 102 may be configured to continuously monitor and measure force or pressure applied to shunt 30 by the shunt drive assemblies 24 in a first direction or by power coil 90 in a second direction. It should be appreciated that each load cell of the first set of load cells 102 may be configured to send at least one signal to a controller of induction furnace 1 when measuring force or pressure applied to shunt 30 by the shunt drive assemblies 24 in the first direction or by power coil 90 in the second direction; such controller of induction furnace 1 is described in more detail below. In one instance, each load cell of the first set of load cells 102 may be configured to periodically send signals to a controller of induction furnace 1 during assembly of induction furnace 1, disassembly of induction furnace 1, or a melting process facilitated by induction furnace 1. In another instance, each load cell of the first set of load cells 102 may be configured to continuously send signals to a controller of induction furnace 1 during assembly of induction furnace 1, disassembly of induction furnace 1, or a melting process facilitated by induction furnace 1.

Similarly, with respect adjustable head system 70, induction furnace 1 may include a second set of load cells 104 that operably engages with the head 80 of the adjustable head system 70. In one instance, as seen in FIG. 7, a first load cell 104A of the second set of load cells 104 may be operably engaged with a head drive assembly 74 of adjustable head system 70 and the head 80. Continuing with this instance, first load cell 104A of the second set of load cells 104 may be operably engaged with the jack 78 of the head drive assembly 74 and the head 80 such that the first load cell 104A is positioned between the jack 78 of the head drive assembly 74 and the head 80.

During operation, second set of load cells 102 may also be configured to continuously monitor and measure force or pressure applied to head 80 by the head drive assemblies 74 in a first direction or by power coil 90 in a second direction. It should be appreciated that each load cell of the second set of load cells 104 may be configured to send at least one signal to a controller of induction furnace 1 when measuring force or pressure applied to head 80 by the head drive assemblies 74 in the first direction or by power coil 90 in the second direction; such controller of induction furnace 1 is described in more detail below. In one instance, each load cell of the second set of load cells 104 may be configured to periodically send signals to a controller of induction furnace 1 during assembly of induction furnace 1, disassembly of induction furnace 1, or a melting process facilitated by induction furnace 1. In another instance, each load cell of the second set of load cells 104 may be configured to continuously send signals to a controller of induction furnace 1 during assembly of induction furnace 1, disassembly of induction furnace 1, or a melting process facilitated by induction furnace 1.

It should be appreciated that the first set of load cells 102 described and illustrated herein may be any suitable, commercially available load cell or pressure device for continuously monitor and measure force or pressure applied to shunt 30 by the shunt drive assemblies 24 in a first direction or by power coil 90 in a second direction. It should also be appreciated that the second set of load cells 104 described and illustrated herein may be any suitable, commercially available load cell or pressure device for continuously monitor and measure force or pressure applied to head 80 by the head drive assemblies 74 in the first direction or by power coil 90 in the second direction.

Induction furnace 1 may also include a controller 110 that electrically connects with the adjustable shunt systems 20, the adjustable head system 70, and the sets of load cells 102, 104. More particularly, controller 110 electrically connects with the shunt drive assemblies 24A, 24B of each adjustable shunt system 20, head drive assemblies 74 of adjustable head system 70, the first set of load cells 102 operably engaged with the adjustable shunt systems 20, and the second set of load cells 104 operably engaged with the adjustable head system 70. As best seen in FIG. 1, a first set of electrical connections or wire 110A electrically connects controller 110 with the shunt drive assemblies 24A, 24B of each adjustable shunt system 20, a second set of electrical connections or wire 110B electrically connects controller 110 with the head drive assemblies 74 of adjustable head system 70, and a third set of electrical connections or wire 110C electrically connects controller 110 with the first set of load cells 102 and the second set of load cells 104. It should be appreciated that while first, second, and third sets of wires 110A, 110B, 110C electrically connects controller 110 with the shunt drive assemblies 24A, 24B of each adjustable shunt system 20, head drive assemblies 74 of adjustable head system 70, the first set of load cells 102, and the second set of load cells 104, any suitable components and/or devices with suitable communication protocols may be used to electrically connect a controller with shunt drive assemblies of each adjustable shunt system, head drive assemblies of an adjustable head system, a first set of load cells operably engaged with the adjustable shunt systems, and a second set of load cells operably engaged with the adjustable head system.

During operation of induction furnace 1, controller 110 is configured to receive information from the first set of load cells 102 as well as the second set of load cells 104 during assembly of induction furnace 1, disassembly of induction furnace 1, or a melting process facilitated by induction furnace 1. Controller 110 is also configured to transmit or send signals to any one of shunt drive assemblies 24A, 24B of each adjustable shunt system 20 upon information received by the first set of load cells 102 during assembly of induction furnace 1, disassembly of induction furnace 1, or a melting process facilitated by induction furnace 1. Similarly, controller 110 is also configured to transmit or send signals to any one of head drive assemblies 74 of adjustable head system 70 upon information received by the second set of load cells 104 during assembly of induction furnace 1, disassembly of induction furnace 1, or a melting process facilitated by induction furnace 1.

Continuing with controller 110, controller 110 may also be configured to control any one of shunt drive assemblies 24A, 24B of each adjustable shunt system 20 as well as any head drive assemblies 74 of adjustable head system 70. In one instance, controller 110 may be configured to control any one of shunt drive assemblies 24A, 24B of each adjustable shunt system 20 between an ON state and an OFF state to automatically adjust each shunt 30 of the adjustable shunt systems 20 where each shunt 30 of the adjustable shunt systems 20 is provided at a desired pressure measured between the respective shunt drive assemblies 24A, 24B and the power coil 90 by measurements taken by the first set of load cells 102. In another instance, controller 110 may be configured to control any one of head drive assemblies 74 of adjustable head system 70 between an ON state and an OFF state to automatically adjust head 80 of the adjustable head system 70 where head 80 of the adjustable head system 70 is provided at a desired pressure measured between the respective head drive assembly 74 and the power coil 90 by measurements taken by the second set of load cells 104. It should be appreciated that controller 110 may simultaneously control each adjustable shunt system 20 and adjustable head system 70 separately and independently from one another when assembling induction furnace 1, disassembling induction furnace 1, or monitoring induction furnace 1 during a melting process.

It should be appreciated that any suitable, commercially available controller may be used for controller 110 to receive data and/or information from the sets of load cells 102, 104 along with controlling the power states of the shunt drive assemblies 24 of each adjustable shunt system 20 and each head drive assembly of adjustable head system 70. It should also be appreciated that controller 110 may be positioned at any desired location relative to the outer shell 10 of induction furnace 1. In one instance, controller 110 may be located outside of chamber 10D of outer shell 10 in which the controller 110 is positioned remote from induction furnace 1. In another instance, controller 110 may be operably engaged with the outer shell 10 and located outside of chamber 10D of outer shell 10. In yet another instance, controller 110 may be located inside of chamber 10D of outer shell 10 in which the controller 110 is positioned inside of induction furnace 1.

Having now described the systems, assemblies, and components of induction furnace 1, methods of monitoring and adjusting induction furnace 1 during melting processes are described in greater detail below.

As seen in FIG. 10, a metal material or charge 120 is introduced into induction furnace 1 through the central opening 82D of the head 80. Prior to introducing charge 120 into induction furnace 1, an electrical current is sent to power coil 90 in order to generate an electromagnetic field inside of induction furnace 1 for either heating and/or mixing processes. Additionally, cooling fluid may also be fed to one or more of the power coil 90, upper cooling coil 92A, and lower cooling coil 92B at desired times during a melting process prior to introducing charge 120 into induction furnace 1, at the time the charge 120 is introduced into induction furnace 1, or subsequent to introducing charge 120 into induction furnace 1. The charge 120 will then remain inside of induction furnace 1 for a desired amount of time until the charge 120 reaches a desired form (e.g., solid form, melted/liquid form, or a combination of solid and liquid form) or mixture inside of induction furnace 1.

During this melting process, controller 110 may be configured to continuously receive information from one or both of the first set of load cells 102 and second set of load cells 104 while controlling the power states of the shunt drive assemblies 24 of each adjustable shunt system 20 and each head drive assembly of adjustable head system 70 based on the data received from the sets of load cells 102, 104. As best seen in FIG. 10, at least one or both of the first load cell 102A and the second load cell 102B may sense or measure a pressure applied against shunt 30 during a melting process for various reasons, including force exerted outwardly by the molten charge 120, force exerted by power coil 90, and other various reasons that may prompt pressure to be applied against shunt 30. Such pressure exerted against shunt 30 by at least the molten charge 120 or the power coil 90 is denoted by arrows labeled “F” in FIG. 10.

In one instance, first load cell 102A and second load cell 102B may send at least one or more signals to the controller 110 during the melting process is response to pressure being applied against the shunt 30 that is within a predetermined range of pressure and/or suitable range of pressure where adjustment of the shunt 30 is not needed. In this situation, shunt drive assemblies 24A, 24B may remain in the OFF state in which the jacks 28 are maintained at the current position and hold the shunt 30 in place.

In another instance, first load cell 102A and second load cell 102B may send at least one or more signals to the controller 110 during the melting process in response to pressure being applied against the shunt 30 that is greater than a predetermined range of pressure and/or suitable range of pressure that adjustment of the shunt 30 is needed. In response to receiving such signals, controller 110 may send signals to one or both of the first shunt drive assembly 24A and second shunt drive assembly 24B in order to relieve and remove pressure from shunt 30. In this illustrated embodiment, controller 110 may send a first signal to motor 26 of first shunt drive assembly 24A to linearly move the jack 28 such that the jack 28 is withdrawn and retracted away from the power coil 90 and into the support column 22. Such withdrawal and retraction of jack 28 in first shunt drive assembly 24A is denoted by an arrow labeled “W1” in FIG. 10. Given first shunt drive assembly 24A is illustrated as a motorized jack screw mechanism, jack 28 is rotated by motor 26 in order to withdraw and retract jack 28 away from the power coil 90 and into the support column 22. Similarly, controller 110 may send a second signal to motor 26 of second shunt drive assembly 24B to linearly move the jack 28 such that the jack 28 is also withdrawn and retracted away from the power coil 90 and into the support column 22. Such withdrawal and retraction of jack 28 in second shunt drive assembly 24B is denoted by an arrow labeled “W2” in FIG. 10. Given second shunt drive assembly 24B is also illustrated as a motorized jack screw mechanism, jack 28 is rotated by motor 26 in order to withdraw and retract jack 28 away from the power coil 90 and into the support column 22. Such commands of withdrawing both jacks 28 of the first and second shunt drive assemblies 24A, 24B may continue until the first and second load cells 102A, 102B measure a pressure that is within the predetermined range of pressure to be experience by shunt 30.

Still referring to FIG. 10, at least one or more load cells of the second set of load cells 104 may also sense or measure a pressure applied against head 80 during a melting process for various reasons, including force exerted outwardly by the molten charge 120, force exerted by power coil 90, and other various reasons that may prompt pressure to be applied against head 80. Such pressure exerted against head 80 by at least the molten charge 120 or the power coil 90 is denoted by arrows labeled “F” in FIG. 10.

In one instance, one or more load cell of the second set of load cells 104 may send at least one or more signals to the controller 110 during the melting process in response to pressure being applied against the head 80 that is within a predetermined range of pressure and/or suitable range of pressure where adjustment of the head 80 is not needed. In this situation, head drive assemblies 74 may remain in the OFF state in which the jacks 78 are maintained at the current position and maintain the head 80 in place.

In another instance, one or more load cell of the second set of load cells 104 may send at least one or more signals to the controller 110 during the melting process in response to the pressure being applied against the head 80 that is greater than a predetermined range of pressure and/or suitable range of pressure where adjustment of head 80 is needed. In response to such signals, controller 110 may send signals to one or more of the head drive assemblies 74 in order to relieve and remove pressure from head 80. In this illustrated embodiment, controller 110 may send a first signal to motor 76 of a head drive assembly 74A to linearly move the jack 78 such that the jack 78 is withdrawn and retracted away from the power coil 90 and the apron 72. Such withdrawal and retraction of jack 78 in head drive assembly 74A is denoted by an arrow labeled “W3” in FIG. 10. Given head drive assembly 74A is also illustrated as a motorized jack screw mechanism, jack 78 is rotated by motor 76 in order to withdraw and retract jack 78 away from the power coil 90 and into the apron 72. Such commands of withdrawing jack 78 of the head drive assembly 74A may continue until the load cell 104A engaged with this head drive assembly 74A measures a pressure that is within the predetermined range of pressure to be experience by head 80.

It should be appreciated that controller 110 may independently and separately control each first and second shunt drive assembly 24A, 24B in each adjustable shunt system 20 such that one or more shunts 30 of adjustable shunt systems 20 avoids experiencing extreme pressure that may lead to warpage and/or deterioration of shunts 30. It should also be appreciated that controller 110 may independently and separately control each head drive assembly 74 in adjustable head system 70 such that head 80 of adjustable head system 70 avoids experiencing extreme pressure that may lead to warpage and/or deterioration of shunts 30.

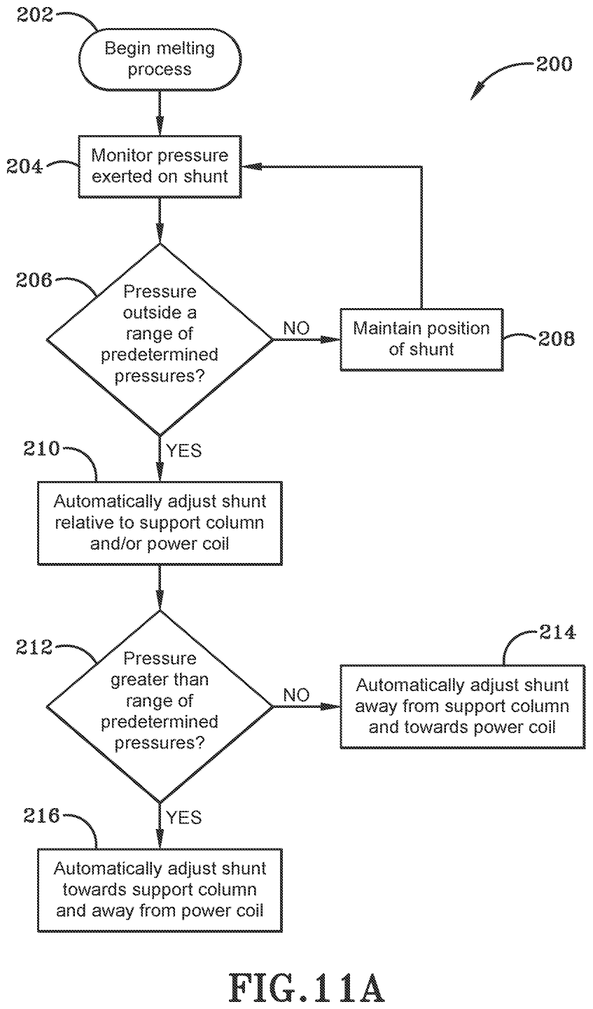

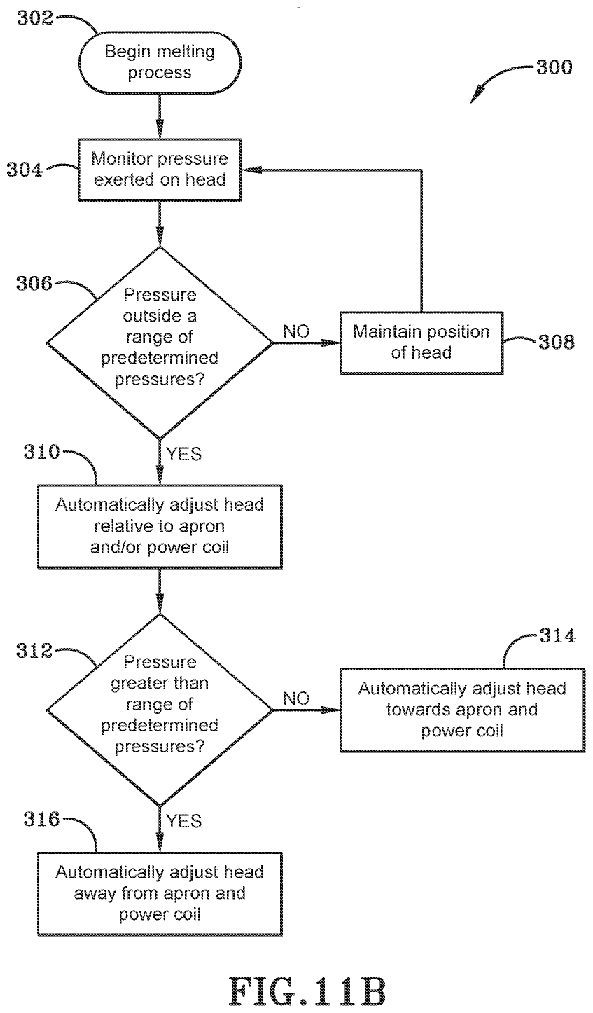

FIG. 11A illustrates a set of instructions 200 that may be provided with controller 110 for monitoring each shunt 30 provided in the adjustable shunt systems 20. Initial step 202 of set of instructions 200 may include beginning the melting process 202 inside of the induction furnace 1. Another step 204 of set of instructions 200 may include monitoring pressure exerted on and/or against each shunt 30 provided in the adjustable shunt systems 20. As described above, controller 110 may be assisted by first set of load cells 102 for monitoring pressure exerted on and/or against each shunt 30 provide in the adjustable shunt systems 20. Another step 206 of set of instructions 200 may include determining if the pressure exerted on each shunt 30 provided in the adjustable shunt systems 20 is outside a range of predetermined pressures based on the measurements taken by first set of load cells 102. If the pressure exerted on a particular shunt 30 provided in the adjustable shunt systems 20 is within the range of predetermined pressures based on the measurements taken by first set of load cells 102, step 208 of set of instructions 200 is utilized by controller 110 in that controller 110 will have the first and second shunt drive assemblies 24A, 24B maintain the position of that particular shunt 30. If the pressure exerted on a particular shunt 30 provided in the adjustable shunt systems 20 is outside the range of predetermined pressures based on the measurements taken by first set of load cells 102, step 210 of set of instructions 200 is utilized by controller 110 in that controller 110 will send at least one signal to first and second shunt drive assemblies 24A, 24B to automatically adjust the position of that particular shunt 30.

Continuing with FIG. 11A, another step 212 of set of instructions 200 may include determining if the pressure exerted on each shunt 30 provided in the adjustable shunt systems 20 is greater than the range of predetermined pressures based on the measurements taken by first set of load cells 102. If the pressure exerted on a particular shunt 30 provided in the adjustable shunt systems 20 is less than the range of predetermined pressures based on the measurements taken by first set of load cells 102, step 214 of set of instructions 200 is utilized by controller 110 in that controller 110 will have the first and second shunt drive assemblies 24A, 24B automatically adjust the position of that particular shunt 30 away from support column 22 and towards power coil 90. If the pressure exerted on a particular shunt 30 provided in the adjustable shunt systems 20 is greater than the range of predetermined pressures based on the measurements taken by first set of load cells 102, step 216 of set of instructions 200 is utilized by controller 110 in that controller 110 will send at least one signal to first and second shunt drive assemblies 24A, 24B to automatically adjust the position of that particular shunt 30 towards support column 22 and away from power coil 90.

Similarly, FIG. 11B illustrates another set of instructions 300 that may be provided with controller 110 for monitoring head 80 of the adjustable head system 70. Initial step 302 of set of instructions 300 may include beginning the melting process 302 inside of the induction furnace 1. Another step 304 of set of instructions 300 may include monitoring pressure exerted on and/or against head 80 of adjustable head system 70. As described above, controller 110 may be assisted by second set of load cells 104 for monitoring pressure exerted on and/or against head 80 of adjustable head system 70. Another step 306 of set of instructions 300 may include determining if the pressure exerted on head 80 of adjustable head systems 70 is outside a range of predetermined pressures based on the measurements taken by second set of load cells 105. If the pressure exerted on head 80 of adjustable head system 70 is within the range of predetermined pressures based on the measurements taken by second set of load cells 104, step 308 of set of instructions 300 is utilized by controller 110 in that controller 110 will have any one of the head drive assemblies 74 maintain the position of head 80 at a particular torque. If the pressure exerted on head 80 of adjustable head system 70 is outside the range of predetermined pressures based on the measurements taken by one of load cells of the second set of load cells 104, step 310 of set of instructions 300 is utilized by controller 110 in that controller 110 will send at least one signal one of the head drive assemblies 74 to automatically adjust the position of head 80 at that particular location where pressure is outside the range of predetermined pressures.

Continuing with FIG. 11B, another step 312 of set of instructions 300 may include determining if the pressure exerted on head 80 in adjustable head system 70 is greater than the range of predetermined pressures based on the measurements taken by second set of load cells 104. If the pressure exerted on head 80 of the adjustable head system 80 is less than the range of predetermined pressures based on the measurements taken by second set of load cells 104, step 314 of set of instructions 300 is utilized by controller 110 in that controller 110 will have at least one head drive assembly 74 automatically adjust head 80 towards apron 72 and towards power coil 90. If the pressure exerted on head 80 of adjustable head system 70 is greater than the range of predetermined pressures based on the measurements taken by second set of load cells 104, step 316 of set of instructions 300 is utilized by controller 110 in that controller 110 will send at least one signal to at least one head drive assembly 74 to automatically adjust the position of head 80 away from support column 22 and away from power coil 90.

It should be appreciated that sets of instructions 200, 300 provided with controller 110 may be performed simultaneously by controller 110 or at different time intervals by controller 100 during a melting process. It should also be appreciated that sets of instructions 200, 300 may be repeated in a single melting process or during multiple melting processes performed inside of induction furnace 1.

While not illustrated herein, such monitoring of shunts 30 in each adjustable shunt system 20 and head 80 of adjustable head system 70 may be used for assembling induction furnace 1 and dissembling induction furnace 1; such methods of assembling induction furnace 1 and dissembling induction furnace 1 with adjustable shunt system 20 and adjustable head system 70 are described in more detail below.

With respect to dissembling induction furnace 1, adjustable shunt system 20 and adjustable head system 70, along with assistance of the first set of load cells 102, the second set of load cells 104, and the controller 110, may be performed automatically rather than using manual labor (as currently required in the art). Prior to dissembling induction furnace 1, the shunts 30 of the adjustable shunt systems 20 and the head 80 of the adjustable head system 70 maintain the power coil 90, the upper cooling coil 92A, and the lower cooling coil 92B at a desired pressured to maintain the shape and position of these coils 90, 92A, 92B inside of the induction furnace 1. In order to remove and dissemble any one of the power coil 90, the upper cooling coil 92A, and the lower cooling coil 92B, controller 110 may send signals to each of the first and second shunt drive assemblies 24A, 24B of adjustable shunt systems 20 to withdraw the shunts 30 away from the power coil 90, the upper cooling coil 92A, and the lower cooling coil 92B until the power coil 90, the upper cooling coil 92A, and the lower cooling coil 92B are free and may be removed from induction furnace 1. Moreover, controller 110 may also send signals to each of the head drive assemblies 74 of adjustable head system 70 to withdraw the head 80 away from the power coil 90, the upper cooling coil 92A, and the lower cooling coil 92B until the power coil 90, the upper cooling coil 92A, and the lower cooling coil 92B are free and may be removed from induction furnace 1. Upon dissembling of induction furnace 1, head 80 may be completely removed from head drive assemblies 74 and apron 72 so that one or more of power coil 90, the upper cooling coil 92A, and the lower cooling coil 92B may be removed from induction furnace 1.

While disassembly of induction may be used to replace and/or repair one or more of the power coil 90, the upper cooling coil 92A, and the lower cooling coil 92B, such disassembly of induction furnace 1 may also be performed for removing, repairing, or replacing other parts inside of induction furnace 1 discussed and illustrated herein by following the same dissembling method discussed above.

With respect to assembling induction furnace 1, adjustable shunt system 20 and adjustable head system 70, along with assistance of the first set of load cells 102, the second set of load cells 104, and the controller 110, may be performed automatically rather than using manual labor (as currently required in the art). Initially, the outer shell 10, adjustable shunt systems 20, adjustable head system 70, sets of load cells 102, 104, and controller 110 may be constructed and/or connected with one another prior to introduce power coil 90, upper cooling coil 92A, and lower cooling coil 92B. Once construction and connections are complete, power coil 90, upper cooling coil 92A, and lower cooling coil 92B may then be introduced into induction furnace 1 and may be loosely fitted with the adjustable shunt systems 20 and adjustable head system 70.

Once power coil 90, upper cooling coil 92A, and lower cooling coil 92B are positioned inside of induction furnace 1, the adjustable shunt systems 20 and adjustable head system 70 may begin to draw and tighten the shunts 30, transition plates 40, and head 80 with the power coil 90, upper cooling coil 92A, and lower cooling coil 92B to a desired pressure. With respect to the shunts 30 and transition plates 40, controller 110 may send first set of signals to motors 26 of first shunt drive assemblies 24A to linearly move the jacks 28 such that the jacks 28 are moved toward the power coil 90, upper cooling coil 92A, and lower cooling coil 92B and away from the support columns 22. Similarly, controller 110 may send a second set of signals to motors 26 of second shunt drive assemblies 24B to linearly move the jacks 28 such that the jacks 28 are moved toward the power coil 90, upper cooling coil 92A, and lower cooling coil 92B and away from the support columns 22. The controller 110 may continue to control the first and second shunt drive assemblies 24A, 24B to press the shunts 30 and transitions plates 40 towards the power coil 90, upper cooling coil 92A, and lower cooling coil 92B based on the pressure measurements taken by the first set of load cells 102. As such, the controller 110 may continue to control the first and second shunt drive assemblies 24A, 24B to press the shunts 30 towards the power coil 90, upper cooling coil 92A, and lower cooling coil 92B until a desired pressure is measured by the first set of load cells 102. At this point, the shunts 30 and transition plates 40 of the adjustable shunt system 20 are engaged with the power coil 90, the upper cooling coil 92A, and the lower cooling coil 92B at a desired torque and/or pressure exerted and maintained by first and second shunt drive assemblies 24A, 24B.

With respect to the head 80, controller 110 may send a third set of signals to motors 76 of head drive assemblies 74 to linearly move the jacks 78 such that the head 80 is drawn downwardly towards the power coil 90, upper cooling coil 92A, and lower cooling coil 92B and towards the apron 72. The controller 110 may continue to control the head drive assemblies 74 to drawn the head 80 downwardly on the power coil 90, upper cooling coil 92A, and lower cooling coil 92B based on the pressure measurements taken by the second set of load cells 104. As such, the controller 110 may continue to control the head drive assemblies 74 to press the head 80 against the power coil 90, upper cooling coil 92A, and lower cooling coil 92B until a desired pressure is measured by the second set of load cells 104. At this point, the head 80 of the adjustable head system 70 is engaged with the power coil 90, the upper cooling coil 92A, and the lower cooling coil 92B at a desired torque and/or pressure exerted and maintained by head drive assemblies 74.

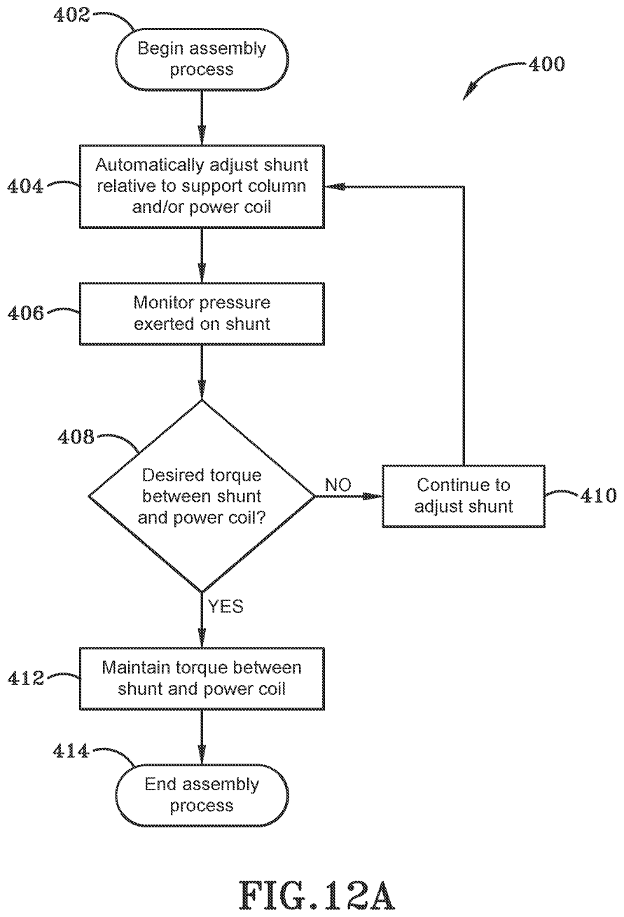

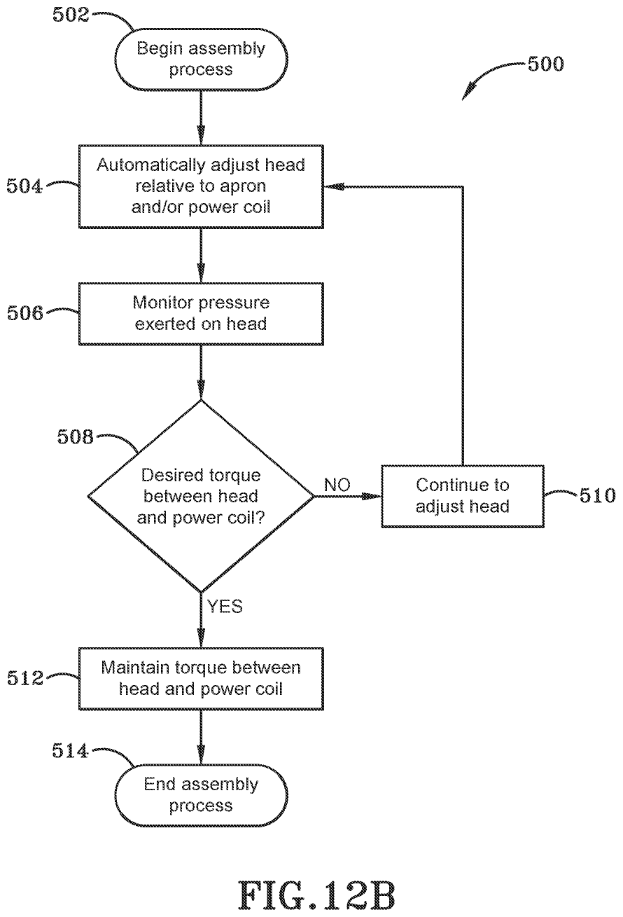

FIG. 12A illustrates a set of instructions 400 that may be provided with controller 110 for assembling each shunt 30 provided in the adjustable shunt systems 20 with at least power coil 90 at a desired torque. Initial step 402 of set of instructions 400 may include beginning the assembling process of the induction furnace 1. Another step 404 of set of instructions 400 may include controller 110 sending at least one signal to first and second shunt drive assemblies 24A, 24B to automatically adjust the position of shunt 30 of each adjustable shunt system 20. Another step 406 of set of instructions 400 may include monitoring pressure exerted on and/or against each shunt 30 provided in the adjustable shunt systems 20. As described above, controller 110 may be assisted by first set of load cells 102 for monitoring pressure exerted on and/or against each shunt 30 provide in the adjustable shunt systems 20. Another step 408 of set of instructions 400 may include determining if the desired torque is applied on a particular shunt 30 and power coil 90 based on the measurements taken by first set of load cells 102. If the desired torque between a particular shunt 30 and power coil 90 is not met based on the measurements taken by first set of load cells 102, step 410 of set of instructions 400 is utilized by controller 110 in that controller 110 continues to automatically adjust this particular shunt 30 until the desired torque is measured between this particular shunt 30 and power coil 90; as such, steps 404 and 406 will be repeated until the desired torque is measured between this particular shunt 30 and power coil 90. If the desired torque between a particular shunt 30 and power coil 90 is met based on the measurements taken by first set of load cells 102, step 412 of set of instructions 400 is utilized by controller 110 in that controller 110 will have the first and second shunt drive assemblies 24A, 24B maintain the position of that particular shunt 30.

Similarly, FIG. 12B illustrates a set of instructions 500 that may be provided with controller 110 for assembling head 80 of adjustable head system 70 with at least power coil 90 at a desired torque. Initial step 502 of set of instructions 500 may include beginning the assembling process of the induction furnace 1. Another step 504 of set of instructions 500 may include controller 110 sending at least one signal to head drive assemblies 74 to automatically adjust the position of head 80 of adjustable head system 70. Another step 506 of set of instructions 500 may include monitoring pressure exerted on and/or against head 80 of adjustable head system 70. As described above, controller 110 may be assisted by second set of load cells 104 for monitoring pressure exerted on and/or against head 80 of adjustable head system 70. Another step 508 of set of instructions 500 may include determining if the desired torque is applied at specific locations on head 80 and power coil 90 based on the measurements taken by second set of load cells 102. If the desired torque between head 80 and power coil 90 is not met based on the measurements taken by one load cell of the second set of load cells 104, step 510 of set of instructions 500 is utilized by controller 110 in that controller 110 continues to automatically adjust head 80 at this particular location until the desired torque is measured between head 80 and power coil 90; as such, steps 504 and 506 will be repeated until the desired torque is measured between head 80 and power coil 90. If the desired torque between head 80 and power coil 90 is met based on the measurements taken by second set of load cells 104, step 512 of set of instructions 500 is utilized by controller 110 in that controller 110 will have the head drive assemblies 74 maintain the position of head 80 with the power coil 90.

It should be appreciated that sets of instructions 400, 500 provided with controller 110 may be performed simultaneously by controller 110 or at different time intervals by controller 100 during assembly or disassembly of induction furnace 1. It should also be appreciated that sets of instructions 400, 500 may be repeated in a single assembly or disassembly process or during multiple assembly or disassembly processes of induction furnace 1.

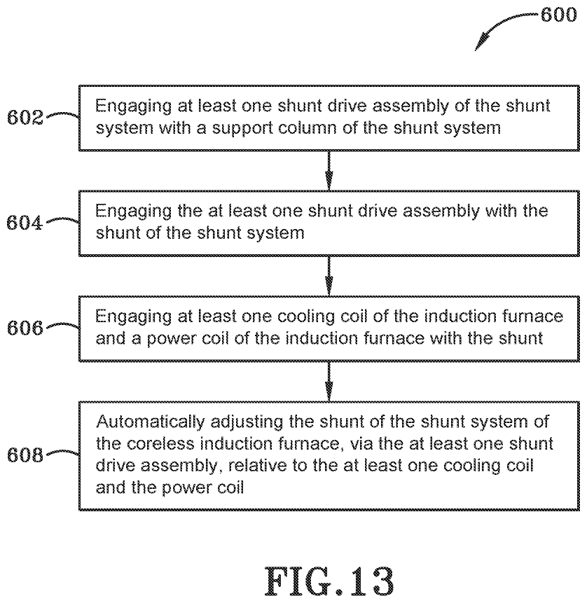

FIG. 13 illustrates a method 600 of automatically adjusting a shunt of a shunt system of an induction furnace. An initial step 602 of method 600 may include engaging at least one shunt drive assembly of the shunt system with a support column of the shunt system. Another step 604 of method 600 may include engaging the at least one shunt drive assembly with the shunt of the shunt system. Another step 606 of method 600 may include engaging at least one cooling coil of the induction furnace and a power coil of the induction furnace with the shunt. Another step 608 of method 600 may include automatically adjusting the shunt of the shunt system of the coreless induction furnace, via the at least one shunt drive assembly, relative to the at least one cooling coil and the power coil.

In other exemplary embodiments, method 600 may include optional or additional steps of automatically adjusting a shunt of a shunt system of an induction furnace. An optional step may further include advancing the shunt away from the support column and towards the at least one cooling coil and the power coil, via the at least one shunt drive assembly, until a desired pressure is maintained between the shunt, the at least one cooling coil, and the power coil. An optional step may further include withdrawing the shunt away from the at least one cooling coil and the power coil and towards the support column, via the at least one shunt drive assembly, until a desired pressure is maintained between the shunt, the at least one cooling coil, and the power coil. Optional steps may further include engaging at least one load cell with the at least one shunt drive assembly and the shunt; and measuring pressure at at least one position on the shunt by the at least one load cell. Optional steps of may further include sending at least one signal to a controller, via the at least one load cell, when the at least one load cell measures a pressure that is outside a predetermined pressure applied against the shunt; and advancing the shunt away from the support column and towards the at least one cooling coil and the power coil, via the at least one shunt drive assembly, until a desired pressure is maintained between the shunt, the at least one cooling coil, and the power coil. Optional steps may further include sending at least one signal to a controller, via the at least one load cell, when the at least one load cell measures a pressure that is outside a predetermined pressure applied against the shunt; and withdrawing the shunt away from the at least one cooling coil and the power coil and towards the support column, via the at least one shunt drive assembly, until a desired pressure is maintained between the shunt, the at least one cooling coil, and the power coil. Optional steps may further include engaging at least another drive assembly with the shunt of the shunt system; and automatically adjusting the shunt of the shunt system of the coreless induction furnace, via the at least another drive assembly, relative to the at least one cooling coil and the power coil; wherein the at least one shunt drive assembly and the at least another drive assembly separately and independently adjust the shunt.

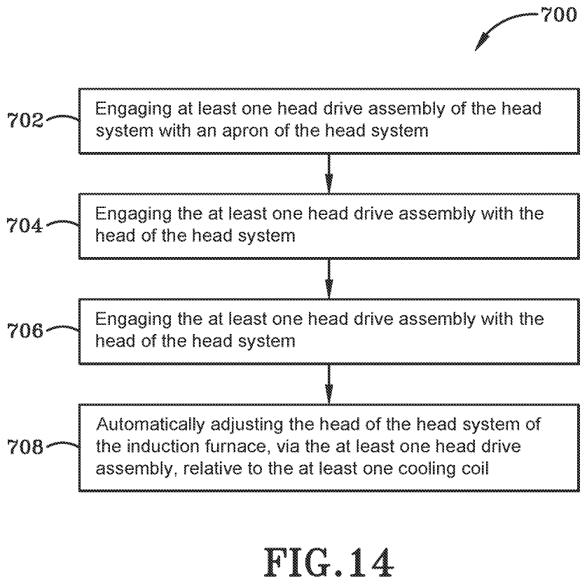

FIG. 14 illustrates a method 700 of automatically adjusting a head of a head system of an induction furnace. An initial step 702 of method 700 may include engaging at least one head drive assembly of the head system with an apron of the head system. Another step 704 of method 700 may include engaging the at least one head drive assembly with the head of the head system. Another step 706 of method 700 may include engaging at least one cooling coil of the induction furnace with the head. Another step 708 of method 700 may include automatically adjusting the head of the head system of the induction furnace, via the at least one head drive assembly, relative to the at least one cooling coil.

In other exemplary embodiments, method 700 may include optional or additional steps of automatically adjusting a head of a head system of an induction furnace. An optional step may further include retracting the head towards the apron and towards the at least one cooling coil and a power coil of the induction furnace, via the at least one head drive assembly, until a desired pressure is maintained between the head, the at least one cooling coil, and the power coil. An optional step may further include withdrawing the head away from the at least one cooling coil and a power coil of the induction furnace and towards the apron, via the at least one head drive assembly, until a desired pressure is maintained between the head, the at least one cooling coil, and the power coil. Optional steps may further include engaging at least one load cell with the at least one head drive assembly and the head, and measuring pressure at at least one position on the head by the at least one load cell. Optional steps may further include sending at least one signal to a controller, via the at least one load cell, when the at least one load cell measures a pressure that is outside a range of predetermined pressures applied against the head; and retracting the head towards the apron and towards the at least one cooling coil and a power coil of the induction furnace, via the at least one head drive assembly, until a desired pressure is maintained between the head, the at least one cooling coil, and the power coil. Optional steps may further include sending at least one signal to the controller, via the at least one load cell, when the at least one load cell measures a pressure that is outside a range of predetermined pressures applied against the head; and withdrawing the head away from the at least one cooling coil and a power coil of the induction furnace and towards the apron, via the at least one head drive assembly, until a desired pressure is maintained between the head, the at least one cooling coil, and the power coil. Optional steps may further include engaging at least another head drive assembly with the head of the head system; and automatically adjusting the head of the head system of the induction furnace, via the at least another head drive assembly, relative to the at least one cooling coil and a power coil of the induction furnace; wherein the at least one head drive assembly and the at least another head drive assembly separately and independently adjust the head.

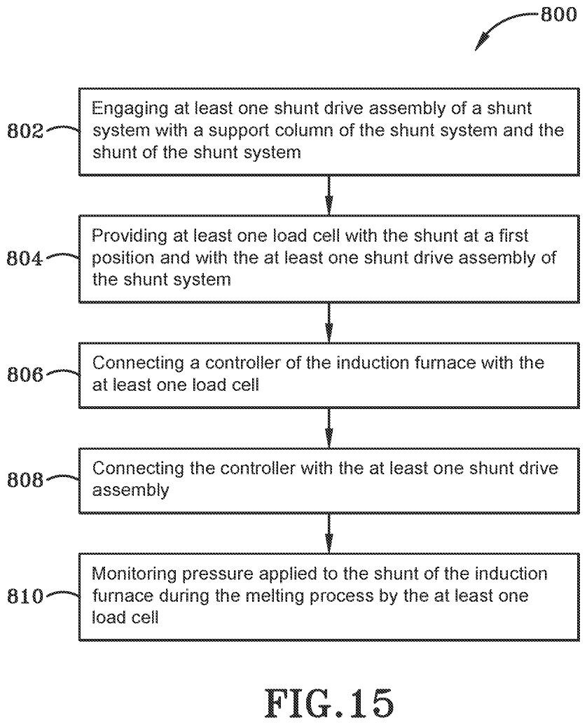

FIG. 15 illustrates a method 800 of monitoring pressure applied to a shunt of an induction furnace during a melting process. An initial step 802 of method 800 may include engaging at least one shunt drive assembly of a shunt system with a support column of the shunt system and the shunt of the shunt system. Another step 804 of method 800 may include providing at least one load cell with the shunt at a first position and with the at least one shunt drive assembly of the shunt system. Another step 806 of method 800 may include connecting a controller of the induction furnace with the at least one load cell. Another step 808 of method 800 may include connecting the controller with the at least one shunt drive assembly. Another step 810 of method 800 may include monitoring pressure applied to the shunt of the induction furnace during the melting process by the at least one load cell.

Optional steps and/or additional steps may further include with method 800 discussed above. An optional step may further include automatically adjusting the shunt of the shunt system, via the at least one shunt drive assembly of the shunt system, relative to at least one cooling coil of the induction furnace and a power coil of the induction furnace during the melting process. Optional steps may further include sending at least one signal to the controller, via the at least one load cell, when the at least one load cell measures a pressure that is outside a range of predetermined pressures applied against the shunt; and advancing the shunt away from the support column and towards at least one cooling coil of the induction furnace and the power coil of the induction furnace, via the at least one shunt drive assembly, until a desired pressure is maintained between the shunt, the at least one cooling coil, and the power coil. Optional steps may further include sending at least one signal to the controller, via the at least one load cell, when the at least one load cell measures a pressure that is outside a range of predetermined pressures applied against the shunt; and withdrawing the shunt away from the at least one cooling coil of the induction furnace and the power coil of the induction furnace and towards the support column, via the at least one shunt drive assembly, until a desired pressure is maintained between the shunt, the at least one cooling coil, and the power coil. Optional steps may further include engaging at least another shunt drive assembly of the shunt system with the shunt of the shunt system; providing at least another load cell with the shunt at a second position and with the at least another shunt drive assembly; and monitoring pressure applied to the shunt by the at least another load cell; wherein the second position is different than the first position. Method may further include that the at least one shunt drive assembly and the at least another shunt drive assembly separately and independently automatically adjust the shunt; and the at least one load cell and the at least another load cell of the shunt system separately and independently monitor the shunt. Optional steps may further include sending at least one signal to the controller, via the at least one load cell or the at least another load cell, when the at least one load cell or the least another cell measures a first pressure that is outside a range of predetermined pressures applied against the shunt; and advancing the shunt away from the support column and towards at least one cooling coil and a power coil, via at least one of the at least one shunt drive assembly and the at least another shunt drive assembly, until a desired pressure is maintained between the shunt, the at least one cooling coil, and the power coil. Optional steps may further include sending at least one signal to the controller, via the at least one load cell or the at least another load cell, when the at least one load cell or the at least another load cell measures a first pressure that is outside a range of predetermined pressures applied against the shunt; and withdrawing the shunt away from the at least one cooling coil and the power coil and towards the support column, via one of the at least one shunt drive assembly and the at least another shunt drive assembly, until a desired pressure is maintained between the shunt, the at least one cooling coil, and the power coil. Optional steps may further include sending at least one signal to the controller, via the at least one load cell, when the at least one load cell measures a first pressure that is outside a range of predetermined pressures applied against the shunt; sending at least another signal to the controller, via the at least another load cell, when the at least another load cell measures a second pressure that is outside the range of predetermined pressures applied against the shunt; and advancing the shunt away from the support column and towards the at least one cooling coil and the power coil, via the at least one shunt drive assembly and the at least another shunt drive assembly of the shunt system, until a desired pressure is maintained between the shunt, the at least one cooling coil, and the power coil. Optional steps may further include sending at least one signal to the controller, via the at least one load cell, when the at least one load cell measures a first pressure that is outside a range of predetermined pressures applied against the shunt; sending at least another signal to the controller, via the at least another load cell, when the at least another load cell measures a second pressure that is outside the range of predetermined pressures applied against the shunt; and withdrawing the shunt away from the at least one cooling coil and the power coil and towards the support column, via the at least one shunt drive assembly and the at least another shunt drive assembly, until a desired pressure is maintained between the shunt, the at least one cooling coil, and the power coil.

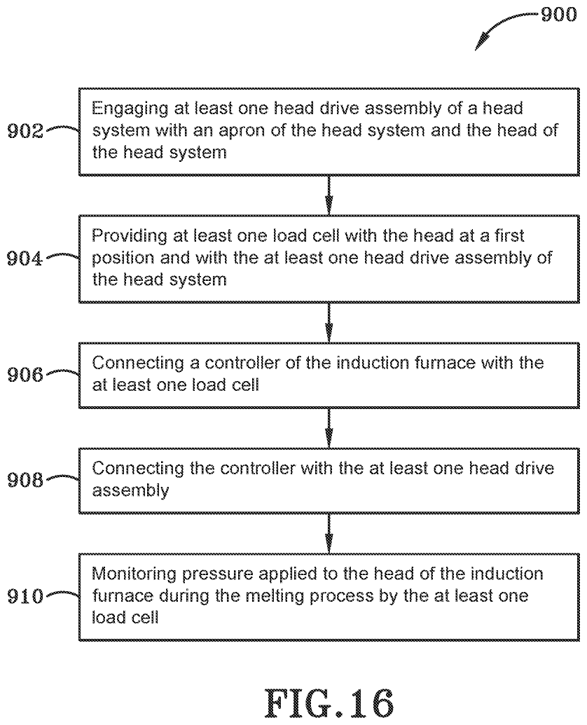

FIG. 16 illustrates a method 900 of monitoring pressure applied to a head of an induction furnace during a melting process. An initial step 902 of method 900 may include engaging at least one head drive assembly of a head system with an apron of the head system and the head of the head system. Another step 904 of method 900 may include providing at least one load cell with the head at a first position and with the at least one head drive assembly of the head system. Another step 906 of method 900 may include connecting a controller of the induction furnace with the at least one load cell. Another step 908 of method 900 may include connecting the controller with the at least one head drive assembly. Another step 910 of method 900 may include monitoring pressure applied to the head during the melting process by the at least one load cell.

Optional steps and/or additional steps may further include with method 900 discussed above. An optional step may further include automatically adjusting the head of the head system, via the at least one head drive assembly, relative to at least one cooling coil of the induction furnace or a power coil of the induction furnace during the melting process. Optional steps may further include sending at least one signal to the controller, via the at least one load cell, when the at least one load cell measures a pressure that is outside a range of predetermined pressures applied against the head; and retracting the head towards the apron and towards at least one cooling coil and a power coil, via the at least one head drive assembly, until a desired pressure is maintained between the head, the at least one cooling coil, and the power coil. Optional steps may further include sending at least one signal to the controller, via the at least one load cell, when the at least one load cell of the head system measures a pressure that is outside a range of predetermined pressures applied against the head; and withdrawing the head away from at least one cooling coil and a power coil and away from the apron, via the at least one head drive assembly, until a desired pressure is maintained between the head, the at least one cooling coil, and the power coil. Optional steps may further include engaging at least another head drive assembly with the head and the apron; providing at least another load cell with the head at a second position and with the at least another head drive assembly; and monitoring pressure applied to the head by the at least another load cell; wherein the second position is different than the first position. Optional steps may further include sending at least one signal to the controller, via the at least one load cell or the at least another load cell, when the at least one load cell or the at least another load cell measures a first pressure that is outside a range of predetermined pressures applied against the head; and advancing the head towards the apron and towards at least one cooling coil and a power coil, via at least one of the at least one head drive assembly and the at least another head drive assembly, until a desired pressure is maintained between the head, the at least one cooling coil, and the power coil. Optional steps may further include sending at least one signal to the controller, via the at least one load cell or the at least another load cell, when the at least one load cell or the at least another load cell measures a pressure that is outside a range of predetermined pressures applied against the head; and withdrawing the head away from the apron and away from the at least one cooling coil and the power coil, via at least one of the at least one head drive assembly and the at least another head drive assembly, until a desired pressure is maintained between the head, the at least one cooling coil, and the power coil. Optional steps may further include sending at least one signal to the controller, via the at least one load cell, when the at least one load cell measures a first pressure that is outside a range of predetermined pressures applied against the head; sending at least another signal to the controller, via the at least another load cell, when the at least another load cell measures a second pressure that is outside the range of predetermined pressures applied against the head; and advancing the head towards the apron and towards the at least one cooling coil and the power coil, via the at least one head drive assembly and the at least another head drive assembly, until a desired pressure is maintained between the head, the at least one cooling coil, and the power coil. Optional steps may further include sending at least one signal to the controller, via the at least one load cell, when the at least one load cell measures a first pressure that is outside a range of predetermined pressures applied against the head; sending at least another signal to the controller, via the at least another load cell, when the at least another load cell measures a second pressure that is outside the range of predetermined pressures applied against the head; and withdrawing the head away from the apron and away from the at least one cooling coil and the power coil, via at least one of the at least one head drive assembly and the at least another head drive assembly of the head system, until a desired pressure is maintained between the head, the at least one cooling coil, and the power coil.

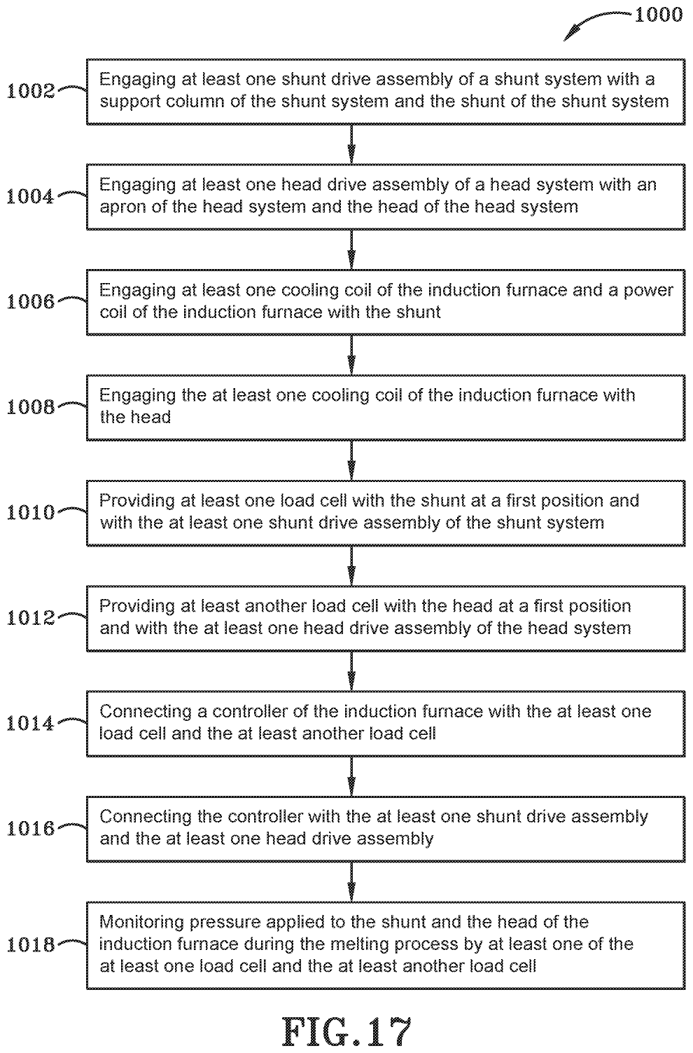

FIG. 17 illustrates a method 1000 of monitoring pressure applied to a shunt and a head of an induction furnace during a melting process. An initial step 1002 of method 1000 may include engaging at least one shunt drive assembly of a shunt system with a support column of the shunt system and the shunt of the shunt system. Another step 1004 of method 1000 may include engaging at least one head drive assembly of a head system with an apron of the head system and the head of the head system. Another step 1006 of method 1000 may include engaging at least one cooling coil of the induction furnace and a power coil of the induction furnace with the shunt. Another step 1008 of method 1000 may include engaging the at least one cooling coil of the induction furnace with the head. Another step 1010 of method 1000 may include providing at least one load cell with the shunt and with the at least one shunt drive assembly of the shunt system. Another step of 1012 of method 1000 may include providing at least another load cell with the head and with the at least one head drive assembly of the head system. Another step 1014 of method 1000 may include connecting a controller of the induction furnace with the at least one load cell and the at least another load cell. Another step 1016 of method 1000 may include connecting the controller with the at least one shunt drive assembly and the at least one head drive assembly. Another step 1018 of method 1000 may include monitoring pressure applied to the shunt and the head of the induction furnace during the melting process.

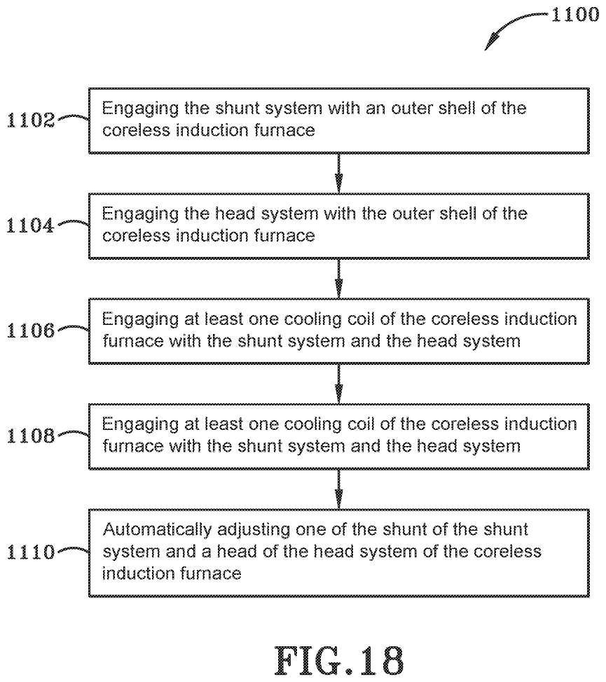

FIG. 18 illustrates a method 1100 of automatically adjusting one of a shunt of a shunt system and a head of a head system of a coreless induction furnace. An initial step 1102 of method 1100 may include engaging the shunt system with an outer shell of the coreless induction furnace. Another step 1104 of method 1100 may include engaging the head system with the outer shell of the coreless induction furnace. Another step 1106 of method 1100 may include engaging at least one cooling coil of the coreless induction furnace with the shunt system and the head system. Another step 1108 of method 1100 may include engaging a power coil of the coreless induction furnace with the shunt system and the at least one cooling coil. Another step 1110 of method 1100 may include automatically adjusting one of the shunt of the shunt system and a head of the head system of the coreless induction furnace.

Optional steps and/or additional steps may further include with method 1100 discussed above. Optional steps may further include that the steps of engaging the shunt system with the outer shell, the at least one cooling coil, and the power coil further comprises: engaging a support column of the shunt system with the outer shell; engaging at least one shunt drive assembly of the shunt system with the support column of the shunt system; engaging the at least one shunt drive assembly with the shunt of the shunt system; engaging the at least one cooling coil of the coreless induction furnace and the power coil of the coreless induction furnace with the shunt; and automatically adjusting the shunt of the shunt system of the coreless induction furnace, via the at least one shunt drive assembly, relative to the at least one cooling coil and the power coil. Optional steps may further include that the steps of engaging the head system with the outer shell and the at least one cooling coil further comprises: engaging an apron of the shunt system with the outer shell; engaging at least one head drive assembly of the head system with the apron of the head system; engaging the at least one head drive assembly with the head of the head system; engaging at least one cooling coil of the coreless induction furnace with the head; and automatically adjusting the head of the head system of the coreless induction furnace, via the at least one head drive assembly, relative to the at least one cooling coil.

The device, assembly, or system of the present disclosure may additionally include one or more sensor to sense or gather data pertaining to the surrounding environment or operation of the device, assembly, or system. Some exemplary sensors capable of being electronically coupled with the device, assembly, or system of the present disclosure (either directly connected to the device, assembly, or system of the present disclosure or remotely connected thereto) may include but are not limited to: accelerometers sensing accelerations experienced during rotation, translation, velocity/speed, location traveled, elevation gained; gyroscopes sensing movements during angular orientation and/or rotation, and rotation; altimeters sensing barometric pressure, altitude change, terrain climbed, local pressure changes, submersion in liquid; impellers measuring the amount of fluid passing thereby; Global Positioning sensors sensing location, elevation, distance traveled, velocity/speed; audio sensors sensing local environmental sound levels, or voice detection; Photo/Light sensors sensing ambient light intensity, ambient, Day/night, UV exposure; TV/IR sensors sensing light wavelength; Temperature sensors sensing machine or motor temperature, ambient air temperature, and environmental temperature; and Moisture Sensors sensing surrounding moisture levels.

The device, assembly, or system of the present disclosure may include wireless communication logic coupled to sensors on the device, assembly, or system. The sensors gather data and provide the data to the wireless communication logic. Then, the wireless communication logic may transmit the data gathered from the sensors to a remote device. Thus, the wireless communication logic may be part of a broader communication system, in which one or several devices, assemblies, or systems of the present disclosure may be networked together to report alerts and, more generally, to be accessed and controlled remotely. Depending on the types of transceivers installed in the device, assembly, or system of the present disclosure, the system may use a variety of protocols (e.g., Wifi, ZigBee, MiWi, Bluetooth) for communication. In one example, each of the devices, assemblies, or systems of the present disclosure may have its own IP address and may communicate directly with a router or gateway. This would typically be the case if the communication protocol is WiFi.

In another example, a point-to-point communication protocol like MiWi or ZigBee is used. One or more of the device, assembly, or system of the present disclosure may serve as a repeater, or the devices, assemblies, or systems of the present disclosure may be connected together in a mesh network to relay signals from one device, assembly, or system to the next. However, the individual device, assembly, or system in this scheme typically would not have IP addresses of their own. Instead, one or more of the devices, assemblies, or system of the present disclosure communicates with a repeater that does have an IP address, or another type of address, identifier, or credential needed to communicate with an outside network. The repeater communicates with the router or gateway.

In either communication scheme, the router or gateway communicates with a communication network, such as the Internet, although in some embodiments, the communication network may be a private network that uses transmission control protocol/internet protocol (TCP/IP) and other common Internet protocols but does not interface with the broader Internet, or does so only selectively through a firewall.

The system that receives and processes signals from the device, assembly, or system of the present disclosure may differ from embodiment to embodiment. In one embodiment, alerts and signals from the device, assembly, or system of the present disclosure are sent through an e-mail or simple message service (SMS; text message) gateway so that they can be sent as e-mails or SMS text messages to a remote device, such as a smartphone, laptop, or tablet computer, monitored by a responsible individual, group of individuals, or department, such as a maintenance department. Thus, if a particular device, assembly, or system of the present disclosure creates an alert because of a data point gathered by one or more sensors, that alert can be sent, in e-mail or SMS form, directly to the individual responsible for fixing it. Of course, e-mail and SMS are only two examples of communication methods that may be used; in other embodiments, different forms of communication may be used.

In other embodiments, alerts and other data from the sensors on the device, assembly, or system of the present disclosure may also be sent to a work tracking system that allows the individual, or the organization for which he or she works, to track the status of the various alerts that are received, to schedule particular workers to repair a particular device, assembly, or system of the present disclosure, and to track the status of those repair jobs. A work tracking system would typically be a server, such as a Web server, which provides an interface individuals and organizations can use, typically through the communication network. In addition to its work tracking functions, the work tracker may allow broader data logging and analysis functions. For example, operational data may be calculated from the data collected by the sensors on the device, assembly, or system of the present disclosure, and the system may be able to provide aggregate machine operational data for a device, assembly, or system of the present disclosure or group of devices, assemblies, or systems of the present disclosure.

The system also allows individuals to access the device, assembly, or system of the present disclosure for configuration and diagnostic purposes. In that case, the individual processors or microcontrollers of the device, assembly, or system of the present disclosure may be configured to act as Web servers that use a protocol like hypertext transfer protocol (HTTP) to provide an online interface that can be used to configure the device, assembly, or system. In some embodiments, the systems may be used to configure several devices, assemblies, or systems of the present disclosure at once. For example, if several devices, assemblies, or systems are of the same model and are in similar locations in the same location, it may not be necessary to configure the devices, assemblies, or systems individually. Instead, an individual may provide configuration information, including baseline operational parameters, for several devices, assemblies, or systems at once.

As described herein, aspects of the present disclosure may include one or more electrical, pneumatic, hydraulic, or other similar secondary components and/or systems therein. The present disclosure is therefore contemplated and will be understood to include any necessary operational components thereof. For example, electrical components will be understood to include any suitable and necessary wiring, fuses, or the like for normal operation thereof. Similarly, any pneumatic systems provided may include any secondary or peripheral components such as air hoses, compressors, valves, meters, or the like. It will be further understood that any connections between various components not explicitly described herein may be made through any suitable means including mechanical fasteners, or more permanent attachment means, such as welding or the like. Alternatively, where feasible and/or desirable, various components of the present disclosure may be integrally formed as a single unit.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, or a combination thereof. When implemented in software, the software code or instructions can be executed on any suitable processor or collection of processors, whether provided in a single computer or distributed among multiple computers. Furthermore, the instructions or software code can be stored in at least one non-transitory computer readable storage medium.

Also, a computer or smartphone may be utilized to execute the software code or instructions via its processors may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers or smartphones may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software/instructions that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, USB flash drives, SD cards, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” or “instructions” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

All definitions, as defined and used herein, should be understood to control over dictionary definitions, definitions in documents incorporated by reference, and/or ordinary meanings of the defined terms.

“Logic”, as used herein, includes but is not limited to hardware, firmware, software, and/or combinations of each to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer-centric or internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve on existing technological processes. The logic(s) provided herein extends beyond merely gathering data, analyzing the information, and displaying the results. Further, portions or all of the present disclosure may rely on underlying equations that are derived from the specific arrangement of the equipment or components as recited herein. Thus, portions of the present disclosure as it relates to the specific arrangement of the components are not directed to abstract ideas. Furthermore, the present disclosure and the appended claims present teachings that involve more than performance of well-understood, routine, and conventional activities previously known to the industry. In some of the method or process of the present disclosure, which may incorporate some aspects of natural phenomenon, the process or method steps are additional features that are new and useful.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments. Furthermore, the use of any and all examples or exemplary language (“e.g.,” “such as,” or the like) is intended merely to better illustrate or illuminate the embodiments and does not pose a limitation on the scope of that or those embodiments. No language in this specification should be construed as indicating any unclaimed element as essential to the practice of the disclosed embodiment.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

To the extent that the present disclosure has utilized the term “invention” in various titles or sections of this specification, or in the context of those sections, this term has been included as required by the formatting requirements of word document submissions (i.e., docx submissions) pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed:

1. An adjustable head system of an induction furnace, the adjustable head system comprising:
a head;
an apron operably engaged with an outer shell of the induction furnace; and
at least one head drive assembly operably engaged with the apron;
wherein the at least one head drive assembly is configured to automatically adjust the head along an axis angled relative to the apron.

2. The adjustable head system of claim 1, wherein when the head is adjusted by the at least one head drive assembly, at least one cooling coil of the induction furnace and a power coil of the induction furnace are adjusted with the head.

3. The adjustable head system of claim 1, wherein the at least one head drive assembly comprises:
a first jack having a first end that operably engages with the head and a second end opposite to the first end; and
a first motor operably engaged with jack;
wherein the first motor is configured to linearly move the first jack and the head along the axis angled relative to the apron.

4. The adjustable head system of claim 3, further comprising:
at least another head drive assembly operably engaged with the apron and the head;
wherein the at least another head drive assembly is configured to automatically adjust the head along a second axis angled relative to the apron and parallel with the axis of the at least one head drive assembly.

5. The adjustable head system of claim 4, wherein each of the at least one head drive assembly and the at least another head drive assembly adjusts the head independently and separately from one another.

6. The adjustable head system of claim 4, wherein the at least another head drive assembly comprises:
a second jack having a first end that operably engages with the head and a second end opposite to the first end; and
a second motor operably engaged with jack;
wherein the second motor is configured to linearly move the jack and the head along the second axis angled relative to the apron.

7. The adjustable head system of claim 6, wherein the apron comprises:
a top end;
a bottom end opposite to the first end; and
a passageway defined between the top end and the bottom end;
wherein the first motor and the second motor operably engage with the apron inside of the passageway.

8. The adjustable head system of claim 7, wherein the first motor and the second motor operably engage with top end of the apron inside of the passageway.

9. The adjustable head system of claim 1, wherein the head comprises:
a top plate operably engaged with the at least one head drive assembly;
wherein the top plate is adjustable relative to the apron and at least one cooling coil of the induction furnace.

10. The adjustable head system of claim 9, wherein the head further comprises:
a refractory member operably engaged with the top plate;
wherein the refractory member is configured to engage with at least one cooling coil of the induction furnace to maintain a desired pressure on the at least one cooling coil and a power coil of the induction furnace.

11. The adjustable head system of claim 10, wherein the top plate comprises:
a top end;
a bottom end operably engaged with the at least one head drive assembly and opposite to the top end; and
a retaining arm extending from the bottom end of the top plate;
wherein the bottom end and the retaining arm are configured to retain the refractory member with the top plate.

12. The adjustable head system of claim 1, further comprising:
at least one load cell operably engaged with the head and the at least one head drive assembly; and
a controller electrically connected with the at least one load cell and the at least one head drive assembly;
wherein the controller is configured to automatically adjust the head, via the at least one head drive assembly, when the at least one load cell measures a pressure that is outside a range of predetermined pressures.

13. The adjustable head system of claim 4, further comprising:
at least one load cell operably engaged with the head and the at least one head drive assembly;
at least another load cell operably engaged with the head and the at least another head drive assembly; and
a controller electrically connected with the at least one load cell, the at least another load cell, the at least one head drive assembly, and the at least another head drive assembly;
wherein the controller is configured to automatically adjust the head, via at least one of the at least one head drive assembly and the at least head another drive assembly, when at least one of the at least one load cell and the at least another load cell measures pressure that is outside a range of predetermined pressures.

14. A method of automatically adjusting a head of a head system of an induction furnace, comprising steps of:
engaging at least one head drive assembly of the head system with an apron of the head system;
engaging the at least one head drive assembly with the head of the head system;
engaging at least one cooling coil of the induction furnace with the head; and
automatically adjusting the head of the head system of the induction furnace, via the at least one head drive assembly, relative to the at least one cooling coil.

15. The method of claim 14, further comprising:
retracting the head towards the apron and towards the at least one cooling coil and a power coil of the induction furnace, via the at least one head drive assembly, until a desired pressure is maintained between the head, the at least one cooling coil, and the power coil.

16. The method of claim 14, further comprising:
withdrawing the head away from the at least one cooling coil and a power coil of the induction furnace and towards the apron, via the at least one head drive assembly, until a desired pressure is maintained between the head, the at least one cooling coil, and the power coil.

17. The method of claim 14, further comprising:
engaging at least one load cell with the at least one head drive assembly and the head; and
measuring pressure at at least one position on the head by the at least one load cell.

18. The method of claim 17, further comprising:
sending at least one signal to a controller, via the at least one load cell, when the at least one load cell measures a pressure that is outside a range of predetermined pressures applied against the head; and
retracting the head towards the apron and towards the at least one cooling coil and a power coil of the induction furnace, via the at least one head drive assembly, until a desired pressure is maintained between the head, the at least one cooling coil, and the power coil.

19. The method of claim 17, further comprising:
sending at least one signal to the controller, via the at least one load cell, when the at least one load cell measures a pressure that is outside a range of predetermined pressures applied against the head; and
withdrawing the head away from the at least one cooling coil and a power coil of the induction furnace and towards the apron, via the at least one head drive assembly, until a desired pressure is maintained between the head, the at least one cooling coil, and the power coil.

20. The method of claim 14, further comprising:
engaging at least another head drive assembly with the head of the head system; and
automatically adjusting the head of the head system of the induction furnace, via the at least another head drive assembly, relative to the at least one cooling coil and a power coil of the induction furnace;
wherein the at least one head drive assembly and the at least another head drive assembly separately and independently adjust the head.
